(19) United States
(12) Patent Application Publication
(10) Pub. No.: US 2021/0208305 A1
(43) Pub. Date: Jul. 8, 2021

(54) MINE PLANNING METHOD AND SYSTEM

(71) Applicant: The University of Melbourne, Melbourne, Victoria (AU)

(72) Inventors: Joachim Hyam Rubinstein, Melbourne, Victoria (AU); Juan Luis Yarmuch, Melbourne, Victoria (AU)

(21) Appl. No.: 17/058,536

(22) PCT Filed: May 28, 2019
(86) PCT No.: PCT/AU2019/050529

§ 371 Date: Nov. 24, 2020

(30) Foreign Application Priority Data
May 28, 2018 (AU) 2018901873

(51) Int. Cl. G01V 99/00; G06F 30/20; G06Q 10/06; E21C 41/26; E21C 41/16

(52) U.S. Cl. CPC G01V 99/005; G06F 30/20; G06F 2111/04; E21C 41/26; E21C 41/16; G06Q 10/0631

(57) ABSTRACT

A method and system for mine design utilising mathematical modelling and optimisation based on mathematical modelling of connected bubbles. A mathematical model, based on mathematical modelling of behavior of connected bubbles, is applied to the 3D block model for a mine to cluster geometric elements from the 3D block model based on physical location and properties of the physical material for each of the geometric elements, and selecting at least one set of a plurality of contiguous geometric elements for extraction based on the clustering. Each set of a plurality of contiguous blocks can be associated with a phase of a mining process.

### TECHNICAL FIELD

The field of the invention is methods and systems for mining design and planning. Applications of the invention are in designing for extraction plans, pushbacks and/or ramps and scheduling.

### BACKGROUND

Mining is the process of extracting valuable material from the earth. Materials extracted from mines include some of the modern world's most important commodities: for example, coal, copper, diamonds, iron, gold, silver, molybdenum, and uranium. After prospecting and geological exploration, mine planners evaluate the mining method, estimate the production capacity and produce detailed exploitation plans.

Mine planning and design aim to plan extraction of material from the mine with the objectives of maximizing yield, minimizing operational costs and compliance with regulatory and safety requirements. Ore deposits are extracted using a variety of mining methods. Among surface mines, quarries and open pit are the most common, while block, panel, sub-level caving and sub-level stopping are usually selected as mining methods in underground mines. The choice of mining method must consider internal and external factors. Natural conditions, investment capability of companies, public policies of the region and the state of art technology should be taken into consideration to evaluate different methods. Among the natural factors, the spatial location and quality of the geological resources, the rock strength, and the topography are the most relevant aspects to be considered.

A typical input to the mine planning is a geological model; in this model geological resources are represented as a block model, a regular-spaced grid of blocks. A 3D block is typically a prismatic shape that is represented by the coordinates of its centroid (x,y,z). This model contains the main information for the planning stage. For instance, rock alteration, mineralisation zones, rock densities and element concentration are fundamental in defining the value of the mine. Mine planners, with the help of other professional disciplines, are responsible for transforming geological resources to ore reserves.

In open cut mining, the Ultimate Pit Limit (UPL) defines the mineable volume of material that generates profits. The size and shape of the pit mostly depends on geotechnical, processing and economic factors. Smaller inner pits are known as intermediate pits. The most common technique used to define the inner pits corresponds to the variation (a fraction) of the commodity selling price. Thus, the ultimate pit limit is calculated for each price. Similar considerations also apply to underground mining or excavation. Working underground can also increase operational constraints and costs.

The UPL is extracted following a development sequence. Pushbacks, phases or mining cuts, are sub-volumes inside the UPL. These volumes must be logically designed, allowing safe operation of the mining equipment (loaders, wheel-dozers, hauling trucks). The main components of the pushbacks are ramps and benches. A bench can be defined as the set of blocks that shares a level inside of a pushback. The pushback should be fully connected by a ramp, and every bench of each pushback must have a minimum width defined by the equipment selected. Therefore, the size and amount of equipment need to be taken into account when pushbacks are designed. The ore tonnage inside pushbacks must be enough to sustain the plant capacity over a period, where typically 1-3 years time is taken.

The output of a successive calculation of inner pits is called the nested pits. Nested pits are used as guidelines to design pushbacks. A ‘Pushback’ represents a region that can be mined in a single continuous operation as defined within the Ultimate Pit. The basic objective is to create a pushback shape which attempts to meet defined primary targets, such as ore tonnage, stripping ratios or mined grade. However, because there is no explicit control in their shape and tonnage, nested pits cannot guarantee a minimum mining width. Therefore, the pushback design requires considerable intervention by mining engineers.

In open cut mining, pushbacks represent phases in open-cut mining, i.e. a series of pits satisfying production requirements and operational constraints for the mining operation. Much value can be gained or lost depending on how well the pushbacks are designed. In particular, due to high capital costs and fluctuations in input costs and commodity prices, mining is inherently risky. To overcome this, mining companies incorporate substantial discount factors into mine planning. Hence early production of high-grade ore is crucial to maximize Net Present Value (NPV) and minimize risk.

During the last 50 years, operations research techniques have been used in the industry to support the mine planning process. However, open pit optimisation models have been limited to a very small number of practical conditions. A challenge for open pit mine planning and design is finding a set of practical pushbacks, their extraction sequence and allocating the material to the appropriate destination.

In 1965, the IBM researchers Lerchs and Grossman (abbreviated LG) published an important graph theoretic method to compute the best value open pit from knowledge of the location of the ore zone. Jeff Whittle was the first person to code a fully 3-dimensional version of the LG algorithm in 1985 and his software became an industry standard. Since then, there have been many improvements and elaborations, but all methods produce approximately the same results. There are now more than ten major software supplier companies to the mining industry, which all have their own approaches to the design of open pit mines. Moreover, some of the big mining companies have their own proprietary software. As well as the design of the pit, scheduling, including logistics, management of stock piles and blending of ore from different mines, are all important features of modern mine planning software.

A key unsolved problem for open cut mines, except for the very smallest ones, is how to produce optimal pushbacks, or mining phases. A pit is developed over a period of anywhere from 2 to 30 or 40 years, depending on the size and depth of the deposit. Pushbacks are then a sequence of nested pits each representing around 2 years of production. For operational and geotechnical reasons, designing these pushbacks is a crucial part of mine planning. If the life of the mine is more than 3-4 years, then pushbacks are required. The majority of open cut mines are of this type.

The LG approach is to (artificially) increase the cost of production, so that smaller and smaller pits are the outcome of their algorithm. This gives a formal way of producing nested pits—an inflated cost of production shrinks the pit in size. However, these nested pits suffer from a number of drawbacks.
The pits may be too narrow in parts, hence operationally infeasible for mining equipment access
The pits may be disconnected, which makes for very inefficient designs, due to the problem of equipment access via ramps.
The size of the nested pits may vary widely, contrary to the requirement of steady production for the refining mill. Typically, each pit should represent about two years of production.

The current practice is that the output of the LG algorithm is used by mine planners as a starting point to produce a practical pushback design, satisfying all production and access requirements. Ramps are required to be added to the design at this stage. Ramps are roads that allow access to the working places. Their maximum slope is constrained by the haulage equipment. The aim of the ramp design is to minimise the construction and operational cost, which includes minimising the hauling distance and traffic congestion. The road design should be included as early as possible because there is a significant difference between a pushback design with and without ramps. To define the layout, engineers need to take into account strategic factors. Pit exit locations, pit geometry, the evolution of the pit shape and the influence of the topography are crucial to minimise the haulage cost. Roads can change the overall shape of the pit dramatically.

This conversion process from an initial semi practical pit design to a practical design is time consuming and value destroying. For example, typically a mining/consultant company might take 2 weeks or more to design pushbacks and ramps. Every mining company has one corporate planning group and each mine site has another planning group. Each group may do around 4 design scenarios a year. Moreover, changing optimised nested pits into practical pushbacks can change the NPV by a substantial amount. Thus, there are time/personnel costs and potentially significant NPV reduction costs associated with conversion to a practical design.

There are no accepted standards and an inexperienced mine planner might produce a design which is far from optimal for NPV. Similarly, there is no reproducibility of good design to provide benchmarking across mining company operations.

There is a need for improvements in mine planning.

### SUMMARY OF THE INVENTION

According to one aspect there is provided a computer implemented method of mine design, the method comprising obtaining a three dimensional (3D) model for a mine, the 3D model characterizing physical material of the mine as a plurality of geometric elements, each geometric element representing a portion of the physical material extractable from the mine, applying a mathematical model, based on mathematical modelling of behavior of connected bubbles, to cluster geometric elements from the 3D model based on physical location and properties of the physical material for each of the geometric elements, and selecting at least one set of a plurality of contiguous geometric elements for extraction based on the clustering. Each set of a plurality of contiguous blocks can be associated with a phase of a mining process.

The mathematical model can include mathematical constraints reflecting operational constraints for the mine type.

In embodiments for an open cut mine the bubble model can be used for pushback design and operational constraints include connectivity, minimum bench width and appropriate angles between pushbacks.

In some embodiments for each pushback the mathematical model balances selection of contiguous geometric elements to minimise geometric surface area while maximizing economic value for each pushback.

In some embodiments, the mathematical model includes a geometric compactness tradeoff factor to enable an operator controllable weighting between maximizing economic value and pushback geometry to be defined and input to the mathematical model.

In some embodiments, the mathematical model comprises:

$$max z = ( 1 - λ ) {\sum }_{p ∈ P} {W}_{p} {\sum }_{b ∈ B} {V}_{b} \cdot {x}_{b} - λ \cdot ( {\sum }_{p ∈ P} {W}_{p} ( {\sum }_{b ∈ B} {S}_{b} \cdot {x}_{b p} - {{\sum }_{b ∈ B}}_{\hat{b} ∈ {\hat{B}}_{b}} {I}_{b \hat{b}} . {y}_{b \hat{b} p} ) )$$

subject to:

$$\begin{matrix}{\sum }_{b ∈ B} {A}_{p} \cdot {x}_{b p} = {\overline{A}}_{p} ∀ p ∈ P & ( 6 ) \\ {x}_{b p} + {x}_{\hat{b} p} - {y}_{b \hat{b} p} \leq 1 ∀ b ∈ B , ∀ \hat{b} ∈ {\hat{B}}_{b ′} ∀ p ∈ P & ( 7 ) \\ {y}_{b \hat{b} p} \leq {x}_{b p} ∀ b ∈ B , ∀ \hat{b} ∈ {\hat{B}}_{b} , ∀ p ∈ P & ( 8 ) \\ {y}_{b \hat{b} p} \leq {x}_{\hat{b} p} ∀ b ∈ B , ∀ \hat{b} ∈ {\hat{B}}_{b} , ∀ p ∈ P & ( 9 ) \\ {\sum }_{ρ \leq p} {x}_{b ρ} \leq {\sum }_{ρ \leq p} {x}_{\overline{b} ρ} ∀ b ∈ B , ∀ \overline{b} ∈ {\overline{B}}_{b} , ∀ p ∈ P & ( 10 ) \\ {\sum }_{p ∈ P} {x}_{b p} \leq 1 ∀ b ∈ B & ( 11 ) \\ ( x , y ) ∈ Ω ( other constraints ) & ( 12 )\end{matrix}$$

### Where:

### Sets and Notation:

b∈B: Set of blocks {0, 1, . . . , B}.
   \hat{b}∈ [symbol] : Set of blocks that are adjacent to block b.
p∈P: Set of pushbacks (clusters) {0, 1, . . . , P}.
b̅∈B̅_{b}: Set of slope precedences for block b.
Parameters:
S_{b}: external surface area of block b
I_{b\hat{b}}: intersecting surface area between block b and \hat{b}
A_{b}: amount of attribute A associated to block b
Āₚ: total amount of attribute A required in pushback p
Wₚ: weight for the pushback p
V_{b}: economic value of block b
λ: compactness factor. Weight (ranging from 0 to 1) to balance the importance of the two objectives in the optimization problem
Variables:
x_{bp}: binary, equal to one if the block b is assigned to pushback p, zero otherwise
y_{b\hat{b}p}: binary, equal to one if blocks b and \hat{b} belongs to pushback p, zero otherwise.

Some embodiments of the method further comprise the steps of adjusting the compactness factor and producing a further pushback design. For underground applications the compactness factor can also be adjusted to produce further excavation plans. In some embodiments the compactness factor is adjusted incrementally to produce a plurality of pushback designs or excavation plans.

According to another aspect, there is provided a method of designing ramps for a set of pushbacks based on a linear programming formulation to find a minimum cost ramp with vertical and horizontal alignment constraints for a given pit and a given ramp width, taking into account stripping associated with ramp excavation, by applying a geological model which is assumed to be represented as a regularly spaced set of blocks including the topography of the pit, and ramp width equivalent to the block size in x or y and the dimension in z represents the maximum ramp slope

$$( max . slope \leq \frac{z}{ϰ} or \frac{z}{y} ) .$$

In an embodiment the ramp design is calculated in accordance with:

### Sets:

N: Set of blocks in the block model.
Aᵢ⁺: Set of blocks j such that there is an arc from j to i.
Aᵢ⁻: Set of blocks i such that there is an arc from i to j.
Γᵢ⁺: Set of vertical precedences of block i (upward).
Γᵢ⁻: Set of vertical precedences of block i (downward).
Rᵢ: Set of all possible ramp directions from block i.
I: Set of possible ramp starting blocks.
E: Set of possible ramp ending blocks.

### Parameters:

cᵢ: extraction cost of block i.
pᵢ^{h,j}: change of direction cost in ramp segment i, where h is the incoming direction and j is the outgoing direction at i with h, j∈Rᵢ and h≠j.

### Variables:

rᵢ: binary, equal to 1 if the block i is selected as a ramp, 0 otherwise.
xᵢ: binary, equal to 1 if the block i is extracted, 0 otherwise.
vᵢ^{h,j}: binary, equal to 1 if the ramp changes direction from h to j (or from j to h) at block i, 0 otherwise (h, j∈Rᵢ and h≠j).
a_{i,j}: binary, for each arc from a block i to a block j equal to 1 if i and j are selected as ramp blocks, 0 otherwise (i≠j).

### Objective Function 4:

$${min}_{ϰ , y} \{ {\sum }_{i ∈ N} {c}_{i} \cdot {x}_{i} + {{{\sum }_{i ∈ N}}_{h , j ∈ {R}_{i}}}_{h \neq j} {p}_{i}^{h , j} \cdot {v}_{i}^{h , j} \} \qquad ( 1 )$$

$$\begin{matrix}{ϰ}_{i} \leq {ϰ}_{j} ∀ i ∈ N , ∀ j ∈ {Γ}_{i}^{+} & ( 2 ) \\ {r}_{i} \leq {ϰ}_{j} ∀ i ∈ N & ( 3 ) \\ {r}_{i} \leq 1 - {ϰ}_{j} ∀ i ∈ N , ∀ j ∈ {Γ}_{i}^{-} & ( 4 ) \\ {a}_{i , j} \leq {r}_{i} ∀ i ∈ N , ∀ j ∈ {R}_{i} & ( 5 ) \\ {a}_{i , j} \leq {r}_{i} ∀ i ∈ N , ∀ j ∈ {R}_{i} & ( 6 ) \\ {r}_{i} + {r}_{j} \leq 1 + {a}_{i , j} ∀ i ∈ N , ∀ j ∈ {R}_{i} & ( 7 ) \\ {\sum }_{j ∈ I} {a}_{x , j} = 1 & ( 8 ) \\ {\sum }_{i ∈ E} {a}_{i , t} = 1 & ( 9 ) \\ {\sum }_{i ∈ t} {a}_{i , x} = 0 & ( 10 ) \\ {\sum }_{j ∈ E} {a}_{t , j} = 0 & ( 11 ) \\ {\sum }_{j ∈ {A}^{-}} {a}_{i , j} = {\sum }_{i ∈ {A}^{+}} {a}_{j , i} ∀ i ∈ N & ( 12 ) \\ {a}_{h , i} + {a}_{i , j} + {a}_{j , i} + {a}_{i , h} \leq {v}_{i}^{h , j} + 1 ∀ i ∈ N , ∀ h , j ∈ {R}_{i} , h \neq j & ( 13 ) \\ {v}_{i}^{h , j} \leq {a}_{h , i} + {a}_{i , j} ∀ i ∈ N , ∀ h , j ∈ {R}_{i} , h \neq j & ( 14 ) \\ {v}_{i}^{h , j} \leq {a}_{j , i} + {a}_{i , h} ∀ i ∈ N , ∀ h , j ∈ {R}_{i} , h \neq j & ( 15 ) \\ {a}_{i , j} + {a}_{j , i} \leq 1 ∀ i , j ∈ N & ( 16 ) \\ {x}_{i} , {r}_{i} , {a}_{i , j} , {v}_{i}^{h , j} ∈ \{ 0 , 1 \} , ∀ i , j ∈ N & ( 17 )\end{matrix}$$

According to another aspect there is provided a computer implemented mine planning method comprising the steps of:
obtaining a mine block model defining three dimensional geological resources of a mine as a regular grid of a plurality prismatic blocks, wherein each block represents a defined volume of material, and wherein block characterization data for each block includes at least coordinate data, physical characteristic data and assigned economic value data;
defining a target pushback tonnage for each pushback; and
determining one or more pushbacks for the mine using the block characterization data, the target pushback tonnage, a plurality of contiguous blocks to comprise the pushback by applying a mathematical model for operational constraints of connectivity, minimum bench width and appropriate angles between pushbacks to select from the mine block model, based on physical location and economic value estimates for each block, a plurality of contiguous blocks having a combined weight equal to or less than the target pushback tonnage to comprise each pushback.

In an embodiment, the mathematical model is based on mathematical modelling of behavior of connected bubbles, and for each pushback the mathematical model balances selection of contiguous blocks to minimise geometric surface area while maximizing economic value for each pushback.

In some embodiments, the mathematical model includes a geometric compactness tradeoff factor to enable an operator controllable weighting between maximizing economic value and pushback geometry to be defined and input to the mathematical model.

In some embodiments the mathematical model comprises:

$${max}_{x , y} \{ {\sum }_{i ∈ N} {v}_{i} \cdot {x}_{i} - c \cdot ( {\sum }_{i ∈ N} 6 \cdot {l}_{i}^{2} \cdot {ϰ}_{i} - {{\sum }_{i ∈ N}}_{j ∈ {Ω}_{i}} {l}_{i}^{2} \cdot {y}_{i , j} ) \}$$

subject to:

$$\begin{matrix}{\sum }_{i ∈ N} {w}_{i} \cdot {x}_{i} - W \leq 0 & ( 4 ) \\ {x}_{i} - {x}_{j} \leq 0 ∀ i ∈ N , ∀ j ∈ {Γ}_{i}^{+} & ( 5 ) \\ {x}_{i} + {x}_{j} - {y}_{i , j} \leq 1 ∀ i ∈ N , ∀ j ∈ {Ω}_{i} & ( 6 ) \\ {ϰ}_{i} , {y}_{i , j} ∈ \{ 0 , 1 \} ∀ i , j ∈ N & ( 7 )\end{matrix}$$

### Where:

N: Set of blocks in the block model
Ωᵢ: Set of adjacent blocks to block i
Γᵢ⁺: Set of vertical precedences of block i (upwards)
c: compactness factor
vᵢ: economic value of block i
lᵢ: length of the block i
w₁: tonnage of the block i
W: total tonnage of the bubble pit
xᵢ: binary, equal to one if the block i is extracted, zero otherwise
y_{i,j}: binary, equal to one if blocks i and j are extracted, zero otherwise.

Some embodiments of the method include further comprising the steps of adjusting the compactness factor and producing a further pushback design. In some embodiments the compactness factor is adjusted incrementally to produce a plurality of pushback designs and further comprising the step of outputting one or more of the plurality of pushback designs.

Some embodiments of the method further comprise the step of performing ramp design for one or more pushback designs. For example, in some embodiment the ramp design is performed in accordance with the method as described above.

According to another aspect there is provided a mine planning system implemented using computer processing and memory resources, the system comprising at least one module configure to implement the methods as described above.

### BRIEF DESCRIPTION OF THE DRAWINGS

FIG. 1a is a flowchart illustrating the current mine planning process;

FIG. 1b is a flowchart showing the change of the mine planning process using an embodiment of the pushback design method the invention.

FIG. 2 illustrates the main outputs of stages of the open pit mine planning process.

FIG. 3 illustrates a flowchart of a bubble pit optimization process.

FIG. 4 illustrates bubble pit graphs showing effect of compactness factor.

FIG. 5 shows the variation of the NPV versus the compactness factor for a prototype test of the pushback design algorithm compared with an engineer prepared design using the same mine data.

FIG. 6 illustrates impact of compactness factor (before introducing unit transformation factor, so ranging from 0 to 200) in the output of the bubble pit model (top view).

FIG. 7 illustrates an example of drawpoint sequencing (Mine sequence optimization for Block caving using concept of ‘Best and worst case.

FIG. 8 illustrates a caving propagation slope.

FIGS. 9a and 9b illustrate scheduled block removal times with two different compactness values.

FIG. 10 illustrates open pit ramps.

FIG. 11 is a block diagram of an embodiment of a system configured to implement the mine planning method.

FIG. 12 is a high level flowchart of the bubble model method.

### DETAILED DESCRIPTION

Disclosed are methods of mine design using a mathematical model based on mathematical modelling of connected bubbles. The disclosed methods can be used for designing pushbacks for open cut mines, or for planning caving or stopping for underground mining. The bubble model can include mathematical constraints reflecting operational constraints for the different mine types.

A high level example of the method is shown in FIG. 12, the process starts by obtaining a three-dimensional (3D) model for a mine 1210, for example by retrieving from a database, system memory or storage media, the 3D model may also be input to the system, for example via email or file transfer. The 3D model characterizes physical material of the mine as a plurality of geometric elements, each geometric element representing a portion of the physical material extractable from the mine. Such models are often referred to as block models. A system processor, appropriately programmed with a mathematical model based on modelling of connected bubbles, applies the mathematical model 1220 to cluster geometric elements from the three-dimensional (3D) model based on physical location and properties of the physical material for each of the geometric elements—this data being extracted from the 3D model. Based on this clustering the processor then selects at least one set of a plurality of contiguous geometric elements for extraction 1230. The properties of the physical material can include any data captured in the 3D model, including economic value for each element.

In the example of an open cut pushback design, the bubble model can include mathematical constraints reflecting the operational constraints of connectivity, minimum bench width and appropriate angles between pushbacks. This model is applied in conjunction with economic data for pushback design. For underground mining the bubble model can also be used.

The present method enables mathematical model based mine planning, which simultaneously satisfy operational constraints and maximize NPV. This could be used by large mining companies with in-house design capability, mining consulting companies and mining software providers.

Embodiments may also be utilised in scheduling aspects of mine planning, for example for planning temporal as well as physical aspects of extraction. It should be appreciated that planning includes extraction of both valuable target material (ore or “pay dirt” carrying the target minerals) and waste material, often referred to as “overburden”, which must be extracted to get to the valuable material. Other required infrastructure such as accessways, roads and or ramps also form part of a comprehensive mine plan and are encompassed within the scope of the present invention.

An input to the mine planning method, as is common to most mine planning, is a 3-dimensional model of the mine characterizing the target material as well as surrounding rock and dirt. The 3D model characterizes physical material of the mine as a plurality of geometric elements, each geometric element representing a portion of the physical material extractable from the mine. The 3D model may be based on core samples and/or seismic data for the mine area. Such 3D models are often referred to as block models.

A 3-dimensional volume is the input to the invention, where the volume is divided into geometrical elements, i.e. small pieces, often called blocks, but could be panels or other larger or irregular sub-regions. The composition of the geometrical elements is known and classified into valuable material, waste and contaminants. The problem is to decide which elements to extract and in what sequence. Constraints include equipment requirements, access, geotechnical stability and others.

The aim of mine planning is to balance maximizing value extracted from the mine with the practical limitations and costs associated with the extraction. In principle, the aim is to extract the maximum volume of valuable material while minimizing total volume extracted. Embodiments of the disclosed methods apply to this optimisation problem; a mathematical model based on mathematical modelling of connected bubbles. The bubble clustering method consists of generating a cluster of elements such that the external surface area of the cluster is minimized; this is done to generate compact and most likely connected clusters. Our clustering method requires that the surface area of each element as well as the surface area of the combination of elements can be computed or estimated.

For simplicity, in the examples given below, the bubble cluster method is applied to a block model, a regular-spaced grid of blocks. A 3D block is typically a prismatic shape that is represented by the coordinates of its centroid (x,y,z) which contains the main information for the planning stage. Therefore, blocks are the basic unit (or elements) that can be part of the clusters. It is worth noting that the bubble cluster are not limited to block models, and the clustering method applies to any framework in which the area of the elements can be minimised. The bubble cluster model has several advantages when applied in the context of mine planning.

Embodiments of the disclosed mine planning methods operate to minimise the boundary surface area of the set of elements chosen to be extracted in a given period of time or the set of elements that satisfies a given characteristic, as a key part of the optimisation process. Such a minimisation produces clusters of elements. There are several advantages of using the disclosed bubble model method for clustering of the chosen elements.
1. If a cluster of elements of a given volume minimises boundary surface area, then the cluster behaves mathematically like a bubble and so will be similar to a round sphere enclosing a given volume. The restriction on size of the cluster corresponds to a mining constraint such as the volume required to be extracted in a given time period. This bubble behavior gives the clusters geometrical shapes with desirable properties, for example, when designing pushbacks or cutbacks, which are a series of nested pits forming an open pit mine. Each such nested pit represents a fixed amount of volume for production, typically around 2-4 years of feed to the processing plant.
2. When scheduling extraction of the chosen elements, minimising boundary surface area of clusters in a similar time period produces regions which are practical for extraction either in surface mining or underground mining. For the efficient use of mining equipment and personnel, the chosen elements should be relatively close together during each time period of production and bubble clusters satisfy this criterion.
3. If blending is required, such as having a minimum ore grade, maximum contaminant, similar rock hardness and geochemical qualities for crushing and refining in a given time period, then using bubble clusters can also produce schedules for efficient extraction. Optimisation then gives a bonus for choosing elements with similar characteristics in a given time period and either a bonus for maximal overlap between the surface areas of the chosen elements or a penalty for the total surface area of the cluster of elements chosen.
4. In underground mining, propagation of rock stress must be controlled using a suitable extraction sequence. Bubble clusters will tend to reduce stress as the clusters will not have ‘sharp corners’ where stress concentrates. This property can be used to optimise the extraction sequence of caving mines as well as defining the mining boundary and sequence of selective mining methods such as stopping mines or any other method that might be beneficiated by using bubble-like clusters.
5. Dump management and stockpiling sequencing consist of moving material from the mine to external facilities (or internal in the case of backfilling) permanently or temporarily. Similarly to the mining process, the dumping and re-handling operations require connected and wide areas to ensure the safe operation of the equipment. The bubble model can also be applied in this context.

Additionally, blending and volume constraints might be required in the sequencing problem for dumps and stockpiles. By subdividing the volume of dumps and stockpiles into geometrical elements and minimising the external surface area of the cluster of elements handled at a similar period, sequences can be generated which are efficient for operations.

### Mathematical Formulation

To generate compact clusters, the following model is based on the bubble principle which is to minimise the surface area for a given volume in a non-homogeneous distribution field. This problem can be formulated as a linear model as follows.

### Bubble Cluster

To introduce the concept of the bubble clusters let us consider a simple version of the problem, where we want to minimise the weighted external surface area of a set of clusters of geometrical elements, such that each cluster contains a given amount of an attribute A. This is a very useful model as the bubble analogy works precisely and there is a lot known about the structure of clusters of planar bubbles.

Let us consider a set of geometrical elements e∈E, such that the surface of each element Sₑ is known and the surface area of any possible clusters can be computed. Despite the fact that there are many ways of computing areas of geometrical surfaces, we will consider that the surface area of a cluster is the sum of the external surface areas of all elements minus the intersecting surface areas of adjacent elements. The latter consideration implicitly assumes that we know (or we can compute) the intersecting surface areas of adjacent elements. Note that our approach is not limited to this method for computing surface areas.

Formally, the simple version of the bubble cluster can be illustrated by the following linear programming formulation.

### Sets and Notation:

e∈E: Set of elements {0, 1, . . . , E}.
ê∈ [symbol] : Set of elements \vec{e}, which are adjacent to element e.
c∈C: Set of clusters {0, 1, . . . , C}.

### Parameters:

Sₑ: external surface area of element e.
I_{eê}: intersecting surface area between elements e and e.
Aₑ: amount of attribute A associated to element e.
Ā_{c}: total amount of attribute A required in cluster c.
W_{c}: weight for the cluster c.

### Variables:

x_{ec}: binary, equal to one if the element e is assigned to cluster c, zero otherwise.
y_{eêc}: binary, equal to one if elements e and e are assigned to cluster c, zero otherwise.

### Objective Function 1:

$$min z = {\sum }_{c ∈ C} {W}_{c} ( {\sum }_{e ∈ E} {S}_{e} \cdot {x}_{e c} - {{\sum }_{e ∈ E}}_{\hat{e} ∈ {\hat{E}}_{e}} {I}_{e \hat{e}} . {y}_{e \hat{e} c} )$$

subject to:

$$\begin{matrix}{\sum }_{e ∈ E} {A}_{e} \cdot {x}_{e c} = {\overline{A}}_{c} ∀ c ∈ C & ( 1 ) \\ {x}_{e c} + {x}_{\hat{e} c} - {y}_{e \hat{e} c} \leq 1 ∀ e ∈ E , ∀ ê ∈ {\hat{E}}_{e} , ∀ c ∈ C & ( 2 ) \\ {y}_{e \hat{e} c} \leq {x}_{e c} ∀ e ∈ E , ∀ ê ∈ {\hat{E}}_{e} , ∀ c ∈ C & ( 3 ) \\ {y}_{e \hat{e} c} \leq {x}_{\hat{e} c} ∀ e ∈ E , ∀ ê ∈ {\hat{E}}_{e} , ∀ c ∈ C & ( 4 ) \\ {\sum }_{c ∈ C} {x}_{e c} \leq 1 ∀ e ∈ E & ( 5 )\end{matrix}$$

### Explanation of Objective Function and Constraints:

The objective function minimises the weighted surface area of the clusters. Constraint (1) ensures that cluster satisfies the total amount of attribute A required, this type of constraint can be generalised for all attributes desired within the clusters. Constraints (2)-(4) identify which adjacent elements belong to the same cluster. Finally, constraint (5) ensures that the elements can only belong to one cluster.

### Open Cut Pushbacks

Open pit pushbacks are “clusters” of blocks that are: 1) connected, 2) satisfy minimum mining width (due to the mining equipment required for the extraction process), 3) the horizontal angle formed by the intersection of two pushbacks is not too small.

Each pushback may have to contain a given amount of different materials such as ore, contaminants, waste. The total volume within the pushbacks is typically between 2-4 years of production. In most cases, traditional methods to define pushbacks (like the Lerchs and Grossman parametrization method) gives impractical pushbacks, i.e. do not satisfy all (or even any) of the three conditions already mentioned. The Bubble cluster method can be used to model the shape constraints of the pushback problem. The following formulation shows a simplified example of the pushback problem, in which the minimisation of the surface area of the bubble clusters corresponds to the second term of the objective function.

A key feature of the disclosed method is to use a proxy, in the form of a mathematical model based on the behavior of soap bubbles, for the operational constraints of connectivity, minimum bench width and appropriate angles between pushbacks. For efficient mining production, each pushback should be a connected region, i.e. not have separated parts. The bench width is set by the requirements of mining equipment for ore production. Narrow angles between pushbacks give regions which are hard to access—having a sufficiently large angle eliminates this problem.

In embodiments of the disclosed method and system, a sequence of pushbacks is modeled as a cluster of soap bubbles. Surface tension of soap bubbles drives them to have the smallest area enclosing a given volume. In the context of mining, the bubble model defines the geometry of a pushback for mining the maximum value material with a minimal geometric surface area.

Using a mathematical bubble model approach gives rise to processes which utilise features inherent to the bubble model to design pushbacks which better address requirements of connectivity, bench width and angles. These requirements are not treated successfully in current mining planning software.

Important mathematical properties of soap bubbles were proved by Jean Taylor in 1976—three soap bubbles meet at an angle of 120 degrees and four soap bubbles meet at a corner at 109.47 degrees. This explains why using a soap bubble model allows us to construct pushbacks with large angles, where the pushbacks meet.

Since soap bubbles have smallest area enclosing a given volume, such a volume will be associated with a single soap bubble in a cluster. For otherwise one can slide two pieces of bubbles enclosing parts of a given volume together to merge to form a larger bubble, enclosing the same volume but with less area. Further, since soap bubbles have constant mean curvature (this is a measure of ‘bending’ of the soap bubble surface) and form shapes like spheres, the minimal bench width property applies, hence giving large bench width.

These geometric features of a soap bubble model inherently address the requirements for pushback design of connectivity, minimum bench width and appropriate angles. Thus, enabling the mathematical bubble model to be applied, gives a proxy for these constraints and provides a geometric framework for the economic analysis involved in pushback design.

Further in some embodiments the practical application of the mathematical model in a mine planning algorithm incorporates a compactness factor, which can be a variable adjusted by the mine planner. The compactness factor is a measure of the dispersion of the blocks that compose the pushback. Or considered another way, it is a mechanism to mathematically enable relaxation of the bubble model geometry from a spherical approximation based on economic aspects. This is explained further in the paragraphs below.

In the bubble model approach, there are two potentially competing objectives—maximizing NPV by taking high value blocks early and minimizing the area of the boundary surface of each pushback, while enclosing a given volume. As discussed above, minimizing surface area to enclose a given volume is an inherent property of a bubble, and so the mathematical model of soap bubble geometry can address the physical objective of minimizing the boundary surface for mine pushbacks. But a purely geometric bubble model approach does not take into consideration the varying economic value of the material to be mined. Thus, the mathematical model of a soap bubble needs to be altered to allow relaxing of the bubble geometry to take into consideration the objective to preferentially mine the more valuable regions and improve NPV. For example, it can be desirable to allow the geometry of the bubble to “stretch” from a perfect sphere to enable encompassing of higher value material. In the mathematical model described herein, a compactness factor is incorporated into the mathematical bubble model to accommodate economic factor based modification of the bubble geometry.

In some embodiments of the current method, the objectives of maximizing NPV by taking high value blocks early and minimizing the area of the boundary surface of each pushback, while enclosing a given volume are combined by taking a weighted sum of the objectives. Hence a percentage of the objective is maximizing NPV and the complementary percentage is for the objective of minimizing area. If we start with 0% contribution of minimizing area and 100% maximizing NPV, the result will be very similar to classical Lerchs Grossman nested pits, with capacity constraints of the bubble model having the only influence on the resulting pushback design. The geometric constraints of the bubble model are negated by the 100% weighting on NPV. At the other end of the spectrum, 100% area and 0% NPV will give perfect soap bubble pushbacks, but will not necessarily give a good value for NPV. It is anticipated that for most mines there will be at least one % compromise where the trade-off between maximizing NPV and minimizing area will provide superior workable pushback designs. It is envisaged that a system embodying the mathematical bubble model method may be used to automatically generate multiple workable pushback designs, each for a different % compromise, so the mine planner may choose a preferred design.

The mine designer can adjust the degree of compactness (i.e. relative percentages of area and NPV) to achieve an appropriate design. In this process, the designer is able to understand the tradeoff between the operational constraints and the current methodology of nested pits, which optimises NPV but does not give practical designs. In particular, this means that for a given mine and ore body, the designer is able to experiment by running multiple designs with different compactness factors to see which one gives the largest NPV but still satisfies the required operational constraints.

Note that area and NPV have different units and are very different in magnitude. To overcome these issues, one disclosed method uses a unit transformation factor, denoted f, which transforms between area of a pushback and dollars of NPV. This enables a compactness factor varying between 0 and 100% to be used.

In another embodiment there is no unit transformation factor needed to compare units of area with units of dollars in NPV so the two terms can be combined. This is on a scale from around 0 to 1000 weighting of the area. Weighting of the area is used since the area is much smaller than the number of dollars in the units typically used. The weighting combines the NPV and area tradeoff into a single value which can be applied to all blocks.

A unit transformation factor can be introduced to convert units of area to units of dollars, then the compactness factor can be thought of as a percentage, as discussed above, saying then we have a certain percent NPV and the complementary percent area.

Underlying this approach is a new algorithm which converts the economic values of the mining blocks into pushbacks, so that there is a balance between the operational constraints and mining the highest value blocks as soon as possible.

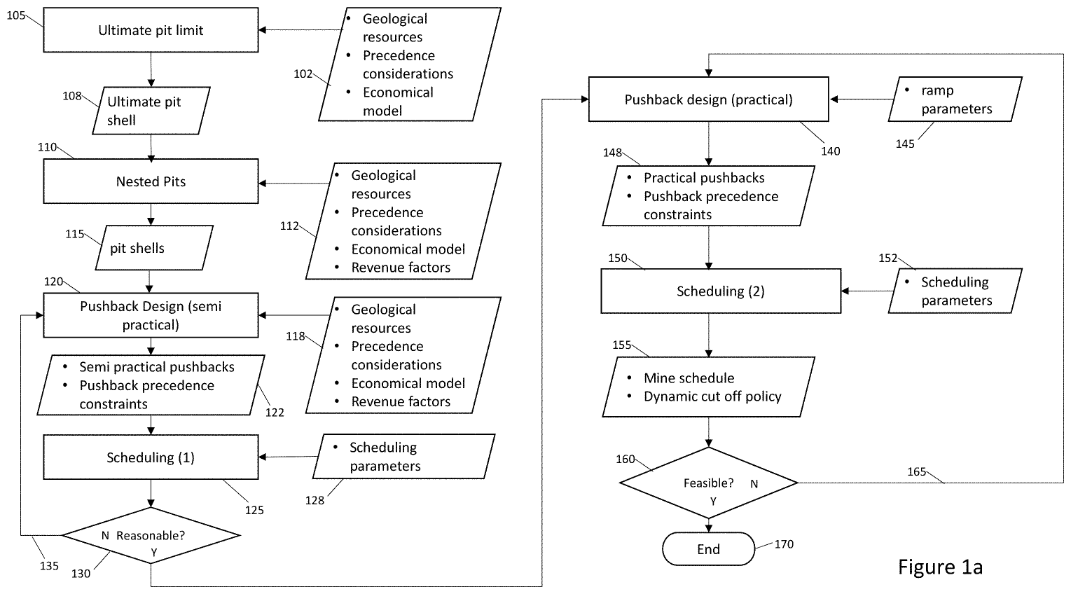

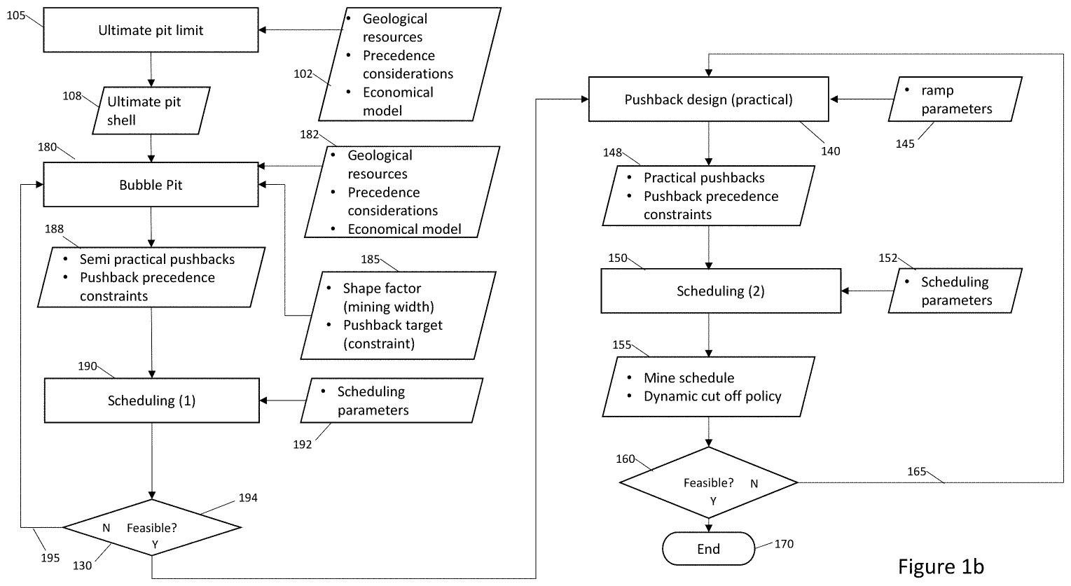

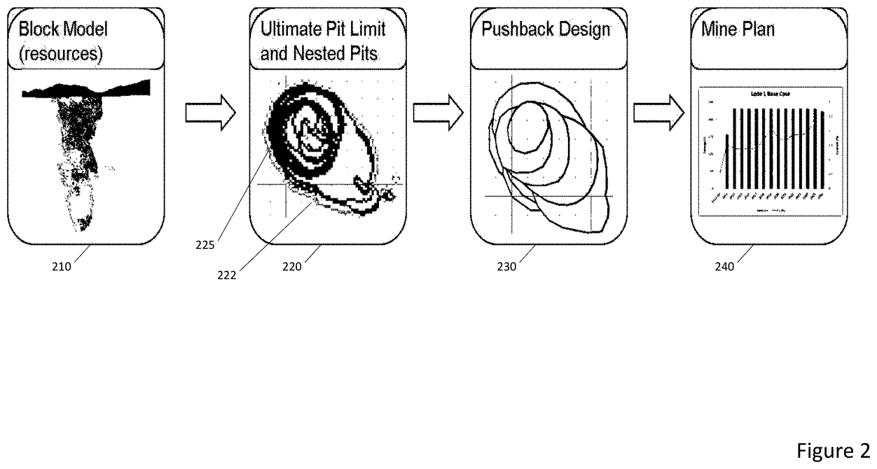

FIGS. 1a and 1b show an example of current mine planning processes in FIG. 1a compared with an alternative mine planning process using embodiments of the disclosed pushback planning method in FIG. 1b. FIG. 2 illustrates the outputs of different phases of mine design process.

FIG. 1a represents the current typical planning procedure. This starts with the input data 102 including geological resource data (for example, a three-dimensional block model 210 produced from exploration which characterizes the type and location of the geological resources illustrated in FIG. 2), precedence constraints and economical models. This data is used to define the ultimate pit limit 108 and geometric ultimate pit shell 222 which defines the 3D boundary of the mine (i.e. shape of the cone) for extraction of the valuable material. This ultimate pit shell 108 is input to a process for designing nested pits 110 using conventional methods. Also input 112 to the nested pit design 110 are geological resource data (block model), precedence constraints, economical models, and revenue factors.

The output from the nested pit design 110 is an initial design of pit shells 115, 225, which is input to a process for designing semi-practical pushbacks 120. Also input to the semi-practical pushback design process is geological resource data (including the block model 210), mining width constraints, and pushback target parameters (for example the tonnage for removal for each pushback). The output 122 from the semi practical pushback design is a set of semi-practical pushbacks 230 and pushback precedence (order) constraints. This semi-practical pushback design 122 is input to a scheduling planning process 125 along with scheduling parameters 128 to determine whether or not the design 122 is feasible 130 for practical implementation. If the design is not feasible 130 then the pushback design 120 and scheduling 125 processing is repeated until a feasible solution is found.

Once a feasible 130 semi-practical pushback design 230 is found, the next step is to convert this to a practical pushback design 140 by adding ramps, based on ramp parameters (for example minimum width and turning angles based on equipment to be used and traffic) to provide a practical pushback design and precedence constraints 148. This is then input to a second scheduling process 150 using scheduling parameters 152 to produce a mine schedule 240 and dynamic cut-off policy 155. This is assessed for feasibility 160 and repeated 165, if necessary, and the design planning process ends 170 once a feasible design and schedule is found. It should be appreciated that the mine designing process is iterative and can be highly manual, taking significant time and resources to produce a feasible design. This entire process may also be repeated to generate multiple feasible plans which may be compared by a mine designer and a preferred one of these feasible designs chosen for implementation.

Embodiments of the disclosed pushback design method can replace the steps of the design process for designing nested pits 110 and designing semi-practical pushbacks 122 (as shown in FIG. 1a), with a single process 180 for designing semi-practical pushbacks 188 based on a bubble model (referred to as bubble pits) as shown in FIG. 1b. Inputs to the bubble pit process 180 include the ultimate pit shell 108, geological resource data (block model), precedence constraints, and economical models 182, similarly to nested pit designs. Also input to the bubble pit processing is shape factor data (mining width constraints and constraints based on 3D cone models) and pushback targets 185. The output from the bubble pit modelling is a semi-practical pushback design and precedence constraints 188 which can be subject to scheduling 190 based on scheduling parameters 192 to assess the feasibility 194 of the design. And the process is repeated 195 if necessary to derive a feasible design or multiple feasible pushback designs for comparison.

The steps for conversion of a semi-practical pushback design to a practical pushback design can be the same as for traditional mine planning processes. An embodiment also provides a ramp design method which may also be used with traditional pushback design methods.

The pushback design method 180 provides a method to design pushbacks for open cut mines, which simultaneously satisfies operational constraints and maximizes NPV, the simultaneous satisfaction of these objectives is not known to be possible with any other mine planning method. Embodiments could be used by large mining companies with in-house design capability, mining consulting companies and mining software providers.

Embodiments fit in the core of the open pit mine planning value chain and allow designers to both optimise and automate the pushback design stage.

The inventors believe their algorithm can solve the optimal pushback design problem. The disclosed method produces designs which can automatically satisfy connectivity and minimum mining width, and optimises NPV with these additional constraints. Embodiments also include a weighting factor which can be selected by a mine planner to adjust trade-offs between optimal NPV and operational constraints, allowing these to be fully explored.

Most mining researchers do not believe that such a solution is possible. An explanation of this is that operational constraints are inherently geometric, so are difficult to capture by standard methods of optimisation (linear and integer programming) used in mining.

The inventor's breakthrough is to use a physical model which forces the operational constraints indirectly but has the correct properties to achieve large scale optimisation, involving huge numbers of variables and constraints. The mathematical characterization of the physical model is used to enable a computer implemented process to automatically or semi-automatically produce pushback designs. This can significantly decrease the time and manual effort associated with mine planning.

One can use the bubble clusters methodology to introduce the connectivity and width constraints to the pushback design problem.

Let us consider a simple instance of the bubble pit problem defined as: find the minimum surface area pit (inverted cone shape) that maximises the economic profit of the total extracted blocks, such that each pit must have a given amount of attribute A. Note that other constraints can be added to represent specific conditions of different mining requirements, but we show this simple problem to illustrate how the bubble clusters can be used in the pushback design problem.

Let us assume a 3D block model, a regularly spaced 3D grid for which every element of the grid is a block (a 3D prism), for this formulation. Our bubble pits (or pushbacks) will be the result of merging a set of prismatic elements, which are the blocks. Note that the slope constraints are superimposed on the problem so that the spherical shapes of bubbles are replaced by cones on planar bubble clusters. These cones have least surface area enclosing a given volume amongst shapes satisfying the slope bounds. Since the problem has multiple objectives, we introduce a factor to weight both objectives. However, our method does not rely on any particular approach to solve multiple-objective optimisation problems.

### Sets and Notation:

b∈B: Set of blocks {0, 1, . . . , B}.
\hat{b}∈ [symbol] : Set of blocks that are adjacent to block b.
p∈P: Set of pushbacks (clusters) {0, 1, . . . , P}.
b̅∈B̅_{b}: Set of slope precedences for block b.

### Parameters:

S_{b}: external surface area of block b
I_{b\hat{b}}: intersecting surface area between block b and \hat{b}
A_{b}: amount of attribute A associated to block b
Āₚ: total amount of attribute A required in pushback p
Wₚ: weight for the pushback p
V_{b}: economic value of block b
λ: compactness factor. Weight (ranging from 0 to 1) to balance the importance of the two objectives in the optimization problem

### Variables:

x_{bp}: binary, equal to one if the block b is assigned to pushback p, zero otherwise
y_{b\hat{b}p}: binary, equal to one if blocks b and \hat{b} belongs to pushback p, zero otherwise.

### Objective Function 2:

$$max z = ( 1 - λ ) {\sum }_{p ∈ P} {W}_{p} {\sum }_{b ∈ B} {V}_{b} \cdot {x}_{b} - λ \cdot ( {\sum }_{p ∈ P} {W}_{p} ( {\sum }_{b ∈ B} {S}_{b} \cdot {x}_{b p} - {{\sum }_{b ∈ B}}_{\hat{b} ∈ {\hat{B}}_{b}} {I}_{b \hat{b}} . {y}_{b \hat{b} p} ) )$$

subject to:

$$\begin{matrix}{\sum }_{b ∈ B} {A}_{p} \cdot {x}_{b p} = {\overline{A}}_{p} ∀ p ∈ P & ( 6 ) \\ {x}_{b p} + {x}_{\hat{b} p} - {y}_{b \hat{b} p} \leq 1 ∀ b ∈ B , ∀ \hat{b} ∈ {\hat{B}}_{b} , ∀ p ∈ P & ( 7 ) \\ {y}_{b \hat{b} p} \leq {x}_{b p} ∀ b ∈ B , ∀ \hat{b} ∈ {\hat{B}}_{b} ∀ p ∈ P & ( 8 ) \\ {y}_{b \hat{b} p} \leq {x}_{\hat{b} p} ∀ b ∈ B , ∀ \hat{b} ∈ {\hat{B}}_{b} , ∀ p ∈ P & ( 9 ) \\ {\sum }_{ρ \leq p} {x}_{b ρ} \leq {\sum }_{ρ \leq p} {x}_{\overline{b} ρ} ∀ b ∈ B , ∀ \overline{b} ∈ {\overline{B}}_{b} , ∀ p ∈ P & ( 10 ) \\ {\sum }_{p ∈ P} {x}_{b p} \leq 1 ∀ b ∈ B & ( 11 ) \\ ( x , y ) ∈ Ω ( other constraints ) & ( 12 )\end{matrix}$$

### Explanation of Objective Function and Constraints:

The multi-objective function maximises the weighted value of the extracted blocks and minimises the area of the bubble pit, combined by a weighting given by the compactness factor λ. Constraint (6) ensures that the pits contain a given amount of attribute A. More than one attribute can be considered in a similar manner, and a tolerance can be added to the mass constraint by replacing the equality constraint with two inequality constraints. Constraints (7)-(9) identify which adjacent elements belong to the same pushback. Constraint (10) represents the vertical precedence (slope wall constraint). Constraint (11) ensures that the blocks can only belong to one pushback. Finally, Constraint (12) might represent other operational restrictions (e.g., block-level or bench-pushback scheduling, mining and processing bounds, variable cut-off grade, blending constraints, and/or the maximum number of pushback opened), and could involve bounds on x and y.

The process of transforming the block model to a valid set of bubble pits is as follow. First, compute the set of parameters of the formulation (B, [symbol] , P, B̅_{b} S_{b}, I_{b\hat{b}}, A_{b}, Āₚ, Wₚ, V_{b}). Second, generate a set of problem instances (for the desired values of compactness factor λ). Third, perform the optimisation of the mathematical model for the set of problem instances. Finally, transform the result from the mathematical model to a block model file.

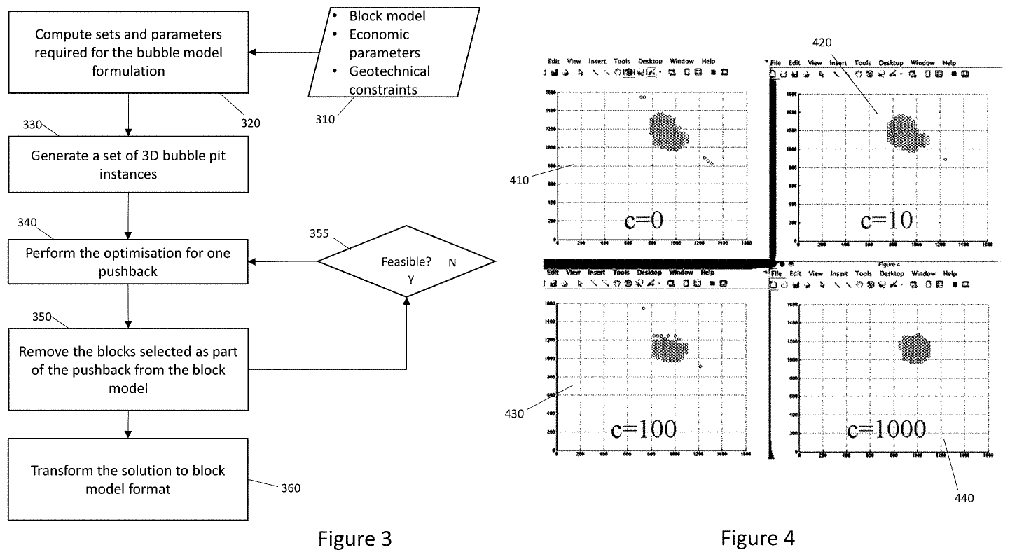

The process of transforming the block model to a valid set of bubble pits is illustrated in the flowchart of FIG. 3. The inputs 310 to the process are:

1. A mine block model
2. Economic parameters—such as the current or predicted ore prices and excavation costs
3. Geotechnical constraints—characterizing requirements for practical application such as not being able to extract a block without having suitable blocks above extracted first. Such constraints are known in the mining industry.

In a first step 320 sets of parameters required for the bubble pit formulation are determined; these parameters include but are not limited to the target weight (tonnage) or volume for each pushback, and the compactness factor.

Based on the input date 310 and determined parameter sets 320 a set of pushback instances are generated using the 3D mathematical bubble model, for example as defined in objective function 2. The set of pushbacks for the ultimate pit is generated by performing the bubble model optimisation for one pushback 340, removing the set of blocks comprising the pushback form the block model 350, and checking whether or not the block model is empty 355. If the block model is not empty the optimisation function will be applied to select blocks for the next pushback. This process is repeated until the block model is empty—all blocks of the block model have been selected and assigned to a pushback. It should be appreciated that the output of the mathematical modelling is a plurality of data sets, one for each pushback with each set defining the blocks selected to comprise the pushback.

Once all blocks have been assigned to a pushback by this modelling process, the data sets defining each pushback can be transformed 360 to a block model format for display and input to further steps of the mine planning process. The transformation to a block model format may include a step of adding to the block characterisation, data for each block within the block model data defining the pushback for which the block has been selected. The steps of scheduling and feasibility assessment, and conversion of feasible designs to practical pushbacks can then proceed in accordance with standard processing.

In some embodiments the pushback design process can include the step of selecting a different compactness factor and repeating the pushback design process using the different compactness factor. This may be done for a range of compactness factor values. The examples below show the impact of varying compactness factor on the pushback designs.

### Computational Experiments

A small size mine, with 2,400 blocks, has been used to test the bubble pit formulation. A maximum total tonnage of the pit was defined as 8,000,000. FIG. 4 shows the effect of the compactness factor for the first pushback. Graph 410 shows the pushback using a compactness factor of 0 (c=0) allowing maximum flexibility in the bubble geometry, and 100% weighting for NPV and 0% for geometric volume. Graph 440 shown a pushback design using a compactness factor of 1000 (c=1000) which represents around 50% weighting to minimise geometric surface area of the pushback, and 50% weighting for maximising NPV. Graphs 420, c=10 and 430 c=100 represent compromise positions and different trade-offs between minimising surface area and maximising NPV, representing around a 15% and 30% weighting for minimising surface area respectively.

### Pushback Design Case Study

A prototype version of a mine planning system has implemented the bubble pit design method in software capable of running on small mines.

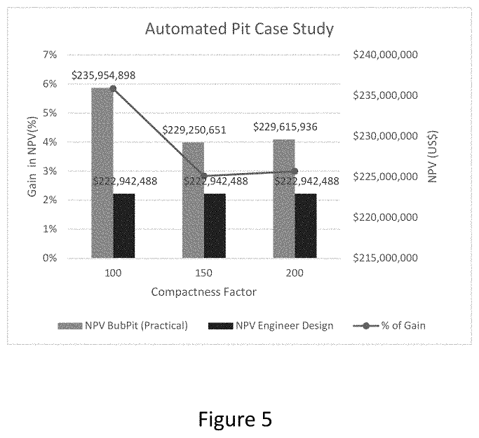

The inventors have also been exploring measures which can be used to compare different design approaches, so that the prototype system and software can be better benchmarked against commercial competitors. The idea is to compare when a pushback is mined in a final design as compared to optimised nested pits. The percentage overlap gives a good measure of how far the design is from the unconstrained optimised solution. The prototype software testing has given outcomes of around 235 MUS$ as compared to 222 MUS$ for an engineer design. So, this demonstrates how much better our algorithm is in forcing practical constraints without deviating too much from the highest value solution. FIG. 5 shows the variation of the NPV versus the compactness factor for a prototype test of the pushback design algorithm compared with an engineer prepared design using the same mine data. In the example of FIG. 5 a compactness factor of 100 was the minimum required to obtain practical designs. (The compactness factor of 100 after introducing the unit transformation factor was 50%).

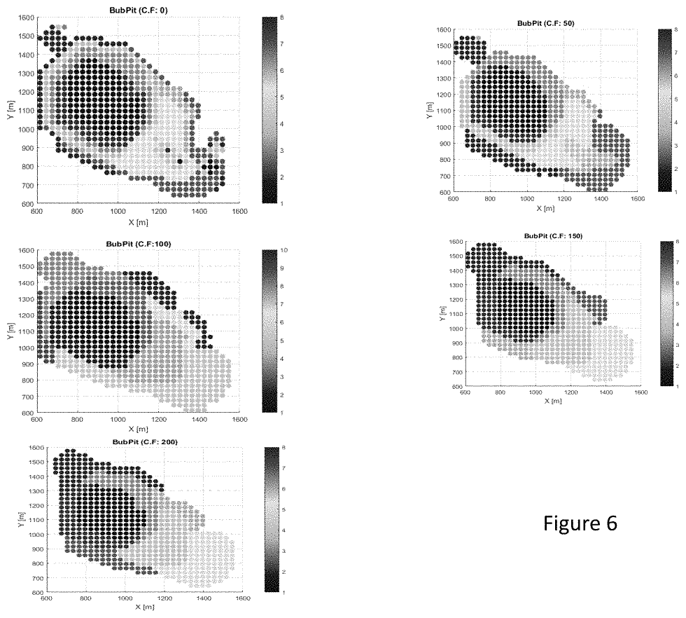

A 3D representation of the output of the bubble pit solution is represented in FIG. 6. Colors represent the position of the pushback generated iteratively with the 3D bubble pit formulation.

### Bubble Schedule

Another application of the bubble clusters methodology is to introduce the connectivity and width constraints to the direct block scheduling problem.

A mine schedule consists of an extraction sequence that satisfies the mining and processing capacity/blending constraints. The extraction sequence must be mineable, i.e. every portion of the mine that is assigned to a period must satisfy practical constraints such as have a minimum width, be connected, etc. The traditional approach for open pit mine scheduling consists of subdividing the pushbacks by bench (or levels) and sequencing the mine using bench-level as the minimum granularity for the problem. Another approach, known as the direct block scheduling (DBS), consists of scheduling the mine block by block over a discretized time frame (periods). This approach has been widely studied in the literature, and recently has been implemented in some commercial software. However, most schedules obtained with the DBS methodology are not mineable. Therefore, the DBS is not suitable to solve the scheduling problem.

The bubble cluster method can be used to control the shape of the set of extracted blocks at each period, treating them as clusters in the DBS problem. As an example, we extend the formulation of the DBS problem, considering a second term in the objective function that stand for the minimisation of the cluster's surface area.

Consider a simple instance of the bubble scheduling problem defined as: find the mining sequence that maximises the economic profit (or other attribute) and minimises the external surface area of the blocks mined at each period, such that production targets are satisfied (single process). Note that other constraints can be added to represent specific conditions of different mining requirements, but we show this simple problem to illustrate how the bubble clusters can be used in the bubble scheduling problem.

Let us assume a 3D block model, a regularly spaced 3D grid for which every element of the grid is a block (a 3D prism), for this formulation. The bubble clusters will be the result of merging a set of prismatic elements, which are the blocks. Note that the slope constraints are superimposed on the problem so that the spherical shapes of bubbles are replaced by cones on planar bubble clusters. These cones have least surface area enclosing a given volume amongst shapes satisfying the slope bounds. Since the problem has multiple objectives, we introduce a factor to weight both objectives. However, our method does not rely on any particular approach to solve multiple-objective optimisation problems.

### Sets and Notation:

b∈B: Set of blocks {0, 1, . . . , B}.
\hat{b}∈ [symbol] : Set of blocks that are adjacent to block b.
t∈T: Set of periods (clusters) {0, 1, . . . , T}.
k∈K: Set of periods (clusters) {0, 1, . . . , K}.
b̅∈B̅_{b}: Set of slope precedences for block b.

### Parameters:

S_{b}: external surface area of block b.
I_{b\hat{b}}: intersecting surface area between block b and \hat{b}.
M̅ₜ: maximum mining capacity (tonnage) at period t.
M_{b}: tonnage of block b.
A_{b}^{k}: amount of attribute k associated to block b.
Āₜ^{k}: maximum amount of attribute k accepted to be process at period t.
Aₜ^{k}: minimum amount of attribute k accepted to be process at period t.
Wₜ: weight for the period t.
P_{b}: profit obtained after processing a ton of material.
C_{b}: mining cost of a tonnage of material.
λ: compactness factor. Weight (ranging from 0 to 1) to balance the importance of the two objectives in the optimization problem

### Variables:

x_{bt}: binary, equal to one if the block b is assigned to period t, zero otherwise
f_{bt}^{p}: fraction of the block b that is sent to process at period t.
f_{bt}^{w}: fraction of the block b that is sent to waste at period t.
y_{b\hat{b}t}: binary, equal to one if blocks b and \hat{b} are mined in period t, zero otherwise.

### Objective Function 3:

$$max z = ( 1 - λ ) {\sum }_{t ∈ T} {W}_{t} {\sum }_{b ∈ B} {M}_{b} \cdot ( {P}_{b} \cdot {f}_{b t}^{p} - {C}_{b} \cdot {x}_{bt} ) - λ \cdot ( {\sum }_{t ∈ T} {W}_{t} ( {\sum }_{b ∈ B} {S}_{b} \cdot {x}_{bt} - {{\sum }_{b ∈ B}}_{\hat{b} ∈ {\hat{B}}_{b}} {I}_{b \hat{b}} . {y}_{b \hat{b} t} ) )$$

subject to:

$$\begin{matrix}{\sum }_{b ∈ B} {M}_{b} \cdot {x}_{b t} \leq {\overline{M}}_{t} ∀ p ∈ P & ( 13 ) \\ {x}_{b t} + {x}_{\hat{b} t} - {y}_{b \hat{b} t} \leq 1 ∀ b ∈ B , ∀ \hat{b} ∈ {\hat{B}}_{b} , ∀ t ∈ T & ( 14 ) \\ {y}_{b \hat{b} t} \leq {x}_{b t} ∀ b ∈ B , ∀ \hat{b} ∈ {\hat{B}}_{b} ∀ t ∈ T & ( 15 ) \\ {y}_{b \hat{b} t} \leq {x}_{\hat{b} t} ∀ b ∈ B , ∀ \hat{b} ∈ {\hat{B}}_{b} , ∀ t ∈ T & ( 16 ) \\ {\sum }_{τ \leq t} {x}_{b τ} \leq {\sum }_{τ \leq t} {x}_{\overline{b} τ} ∀ b ∈ B , ∀ \overline{b} ∈ {\overline{B}}_{b} , ∀ t ∈ T & ( 17 ) \\ {\sum }_{t ∈ T} {x}_{b t} \leq 1 ∀ b ∈ B & ( 18 ) \\ {\sum }_{t ∈ T} {f}_{b t}^{p} \leq 1 ∀ b ∈ B & ( 19 ) \\ {\sum }_{t ∈ T} {f}_{b t}^{w} \leq 1 ∀ b ∈ B & ( 20 ) \\ {x}_{b t} = {f}_{b t}^{p} + {f}_{b t}^{w} ∀ b ∈ B , ∀ t ∈ T & ( 21 ) \\ {\underline{A}}_{t}^{k} \leq {\sum }_{b ∈ B} {A}_{b}^{k} \cdot {f}_{b t}^{p} \leq {\overline{A}}_{t}^{k} ∀ t ∈ T , ∀ k ∈ K & ( 22 ) \\ ( x , y ) ∈ Ω ( other constraints ) & ( 23 )\end{matrix}$$

### Explanation of Objective Function and Constraints:

The multi-objective function maximises the weighted value of the scheduled blocks and minimises the surface area of the blocks extracted in each period, combined by a weighting given by the compactness factor λ. Constraint (13) ensures that extraction does not exceed the maximum mining capacity. Constraints (14)-(16) identify which adjacent elements are extracted at the same period. Constraint (17) represents the vertical precedence (slope wall constraint). Constraints (18-21) ensure that the blocks can be extracted and processed in only one period. Constraint (22) enforces that processed material satisfies the processing blending requirements. Finally, constraint (23) might represent other operational restrictions (e.g., block-level or bench-pushback scheduling, stockpiling/re-handling constraints, and/or dumps capacity), and could involve bounds on x and y.

Similarly to the bubble pit procedure, the process of transforming the block model to a valid bubble scheduling is as follow. First, compute the set of parameters of the formulation (B, [symbol] , T, B̅_{b}, K, M̅ₜ, A^{k}_{b}, Āₜ^{k}, Aₜ^{k}, Wₜ, P_{b}, C_{b}, λ). Second, generate a set of problem instances (for the desired values of compactness factor λ). Third, perform the optimisation of the mathematical model for the set of problem instances. This may be performed iteratively until a satisfactory or optimal extraction schedule solution is found. Finally, transform the result from the mathematical model to a block model file. In some embodiments, the scheduling process can include the step of selecting a different compactness factor and repeating the optimisation. This may be done for a range of compactness factor values.

### Bubble Cave

There are a variety of underground mining methods, where the selection of the method mostly depends on the geomechanical characteristics of the ore and the host rock.

Underground methods can broadly be divided into selective and massive (or caving) methods. Examples of caving methods are block caving, panel caving and sublevel caving. The sequencing problem for block and panel caving mines consists of defining the sequence of contiguous drawpoints (extraction points) that need to be opened during the life of the mine, some examples are shown in FIG. 7.

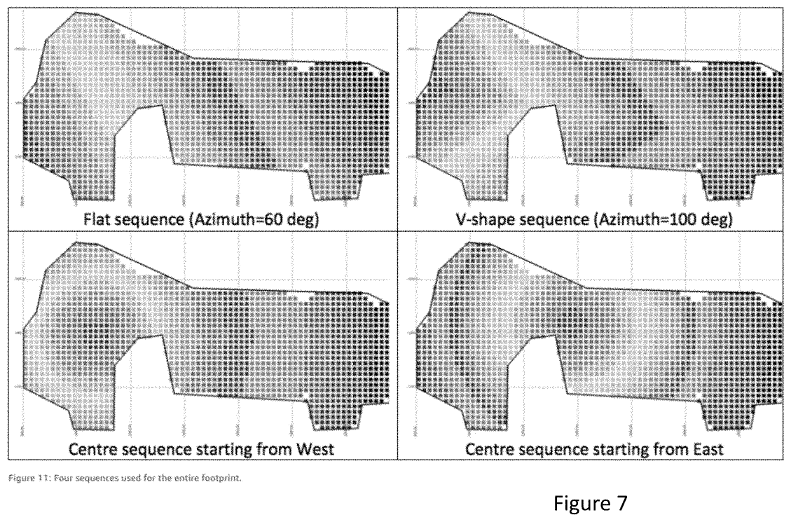

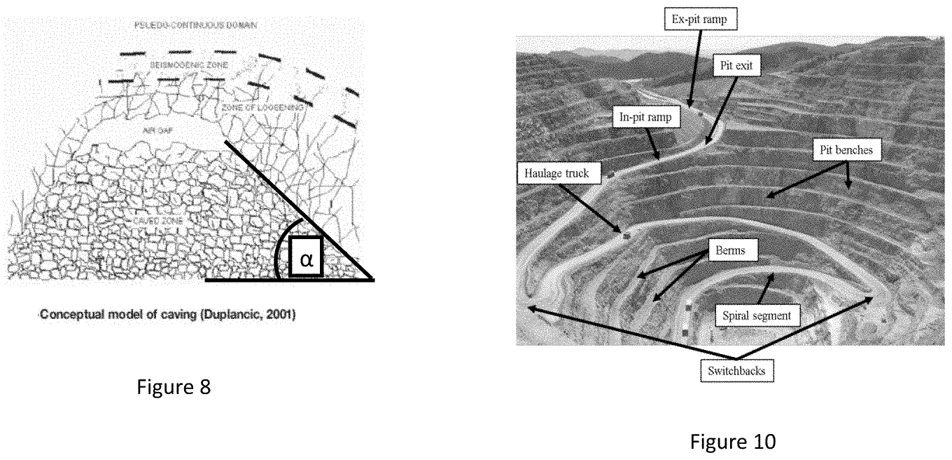

Once the drawpoints are opened, the change of the in-situ stresses induces the propagation of the caving, beginning the gravitational flow of the material. The material that is above a drawpoint is called a column. Generally, the drawpoints share the same extraction level (footprint). Additionally, the caving propagation slope (the vertical slope that forms the broken material) mainly depends on geomechanical factors as well as the mining rates; an example is shown in FIG. 8. The caving propagation slope can be modelled as a precedence constraint for a given set of geomechanical conditions and mining factors. Thus, considering both the drawpoints and the extraction columns as geometrical elements (for example regular blocks), the bubble cluster method can be used to optimise the mining sequence of caving mines. The precedence constraints defined by the caving propagation act similarly to the wall slope constraint in open pit mines. Other sets of operational constraints might be required to model other mining methods or situations. Note that the use of bubble clusters in the model tends to generate rounded shapes which may reduce the stress concentration in sharp corners of excavated volumes.

Underground ore extraction methods such as block caving and panel caving can be modelled as an inverted open pit mine, where the slope constraint is given by the caving propagation angle. Therefore, the same mathematical formulation can be applied to approach and solve caving design problems. Moreover, if constraint (5) from the 3D bubble pit formulation is removed, the resulting model might be sufficient to design the optimal boundary of underground stoping mines.

In large scale underground mines, there are several key problems which the bubble approach may successfully overcome. The first is to minimise geotechnical stress which can build up from ore removal. There are standard methods to deal with this, such as leaving pillars and filling cavities with waste and paste mix. A bubble shape may give substantial improvement on the distribution of geotechnical stress.

Another problem is over-break, where blasting can mix unwanted waste material with ore. Again, using bubble designs for stopes (mineable units) may decrease over-break, as the designs should yield more stable shapes than conventional stope designs.

### Computational Experiments

Real mining data was used to test the bubble scheduling formulation. A particular bench (level) of an iron ore mine was selected. The problem instance consisted of scheduling 3076 blocks over 5 periods. A mining and processing capacity of 1,200,000 and 800,000 tons per period was considered. Additionally, two blending constraints over attribute Fe (Iron) and Si (Silica) were required to satisfy the processing plant requirements. Thus, the processed material must have a minimum content of Fe of 55%, and a maximum content of Si of 5%.

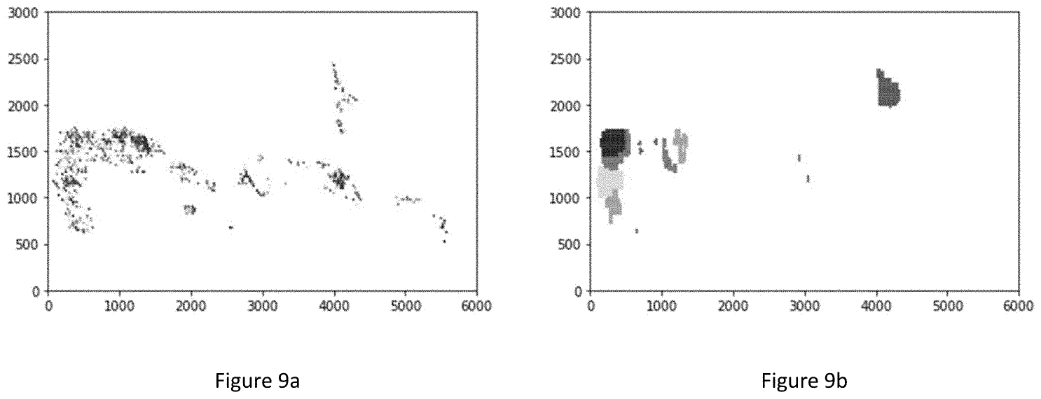

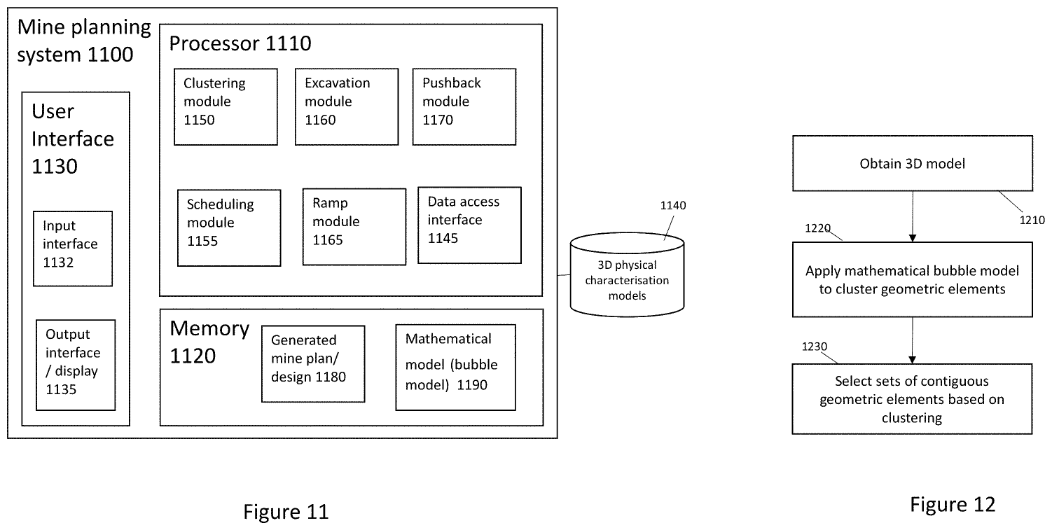

Two cases of compactness factors were studied, the first one considering λ equal to zero (FIG. 9a) and the second, considering a value of λ equal to 1 (FIG. 9b). Colors represent the time when the blocks should be extracted. The value of λ equal to zero means that we are not imposing any constraints over the clusters (no bubble clusters), therefore it is not surprising to see that blocks scheduled at each period are quite scattered in location. On the other hand, when λ is equal to 1 we are purely minimising the external surface area of the set of blocks scheduled by period.

A significant advantage is that bubble scheduling for a problem requiring blending constraints is able to construct sequences of blocks per period, which are practical to extract, as they are contiguously located. Scheduling for maximum NPV does not produce such sequences and so manual smoothing of the schedule is required, which will be time-consuming and destroy value.

### Ramp Design

During the mine exploitation, the ore is hauled to processing plants, while waste material is transported to waste dumps. Thus, open pit mines require a complete road network which connects the extraction sectors inside the pit to all possible destinations outside the pit. In-pit ramps are roads that connect the working phases to the pit exits; these require the removal of a great amount of material for their construction. The total tonnage of ore and waste and the pit shape can change dramatically after the addition of the in-pit ramps.

In-pit ramps must connect the bottom of the pit to a given pit exit at the top of the excavation (see FIG. 10). It is important to note that conditions, such as poor rock quality strength, could disqualify some sectors of the pit for ramp construction. In addition, material above the ramp must be extracted to satisfy the maximum condition of pit wall slope. Decision variables of the problem are, the ramp starting point (at the bottom of the pit), the direction and slope of each section of the ramp spiral, and the number and locations of switchbacks, where the ramp makes a sharp turn.

Each practical pushback must have a ramp from top to bottom. Therefore, a natural step after the calculation of semi-practical pushbacks with the bubble pit formulation is to design a ramp for each pushback.

Current practice is for ramps to be designed using CAD tools. There are no commercial tools available currently to design ramps automatically.

A major advantage of incorporating an automatic ramp design tool together with the bubble pit pushback method is that realistic scheduling production of the mine can then be achieved. In particular, an accurate economic valuation of the design can be performed and mine planners can run multiple designs to test economic assumptions about commodity prices. Current practice is to perform a rough best- and worst-case analysis, which gives rather crude bounds on the value of a design.

For this purpose, we present a linear programming formulation to find a minimum cost ramp with vertical and horizontal alignment constraints for a given pit and a given ramp width. This formulation takes into account the stripping associated with the ramp excavation. (Stripping is the removal of material above the ramp to satisfy the slope conditions).

The objective is to find the least cost ramp, with the physical constraint of slope bound, where the major cost is stripping but also an additional term is added for each sharp turn, i.e. a switch-back. This can take into account extra maintenance and haulage costs. The ramp is built then to run from the top to the bottom of the pit. The initial and final points can be either be pre-determined or determined by the design.

The excavation cost, the topography and the initial and final ramp coordinates are the main inputs of the problem. The geological model is assumed to be represented as a regularly spaced set of blocks (equal dimensions in coordinates x and y) and must include the topography of the pit. We assume the ramp width is equivalent to the block size in x or y and the dimension in z represents the maximum ramp slope

$$( max . slope \leq \frac{z}{ϰ} or \frac{z}{y} ) .$$

For a standard block model this may necessitate, first, dividing every block into several horizontal slices. An arc is a small segment of path from a block to an adjacent block. The blocks are labelled by integers.

To consider the stripping associated with the ramp, we define a set of vertical precedences (upward), or blocks above the ramp, that need to be extracted to ensure a minimum wall slope. Similarly, to avoid the construction of the ramp above excavated blocks, we consider a set of vertical precedences (downward) to ensure a feasible design. Additionally, two artificial blocks, the source block s and the sink block t, are created to preserve the flow in the graph.

### Sets:

N: Set of blocks in the block model.
Aᵢ⁺: Set of blocks j such that there is an arc from j to i.
Aᵢ⁻: Set of blocks i such that there is an arc from i to j.
Γᵢ⁺: Set of vertical precedences of block i (upward).
Γᵢ⁻: Set of vertical precedences of block i (downward).
Rᵢ: Set of all possible ramp directions from block i.
I: Set of possible ramp starting blocks.
E: Set of possible ramp ending blocks.

### Parameters:

cᵢ: extraction cost of block i.
pᵢ^{h,j}: change of direction cost in ramp segment i, where h is the incoming direction and j is the outgoing direction at i with h, j∈Rᵢ and h≠j.

### Variables:

rᵢ: binary, equal to 1 if the block i is selected as a ramp, 0 otherwise.
xᵢ: binary, equal to 1 if the block i is extracted, 0 otherwise.
vᵢ^{h,j}: binary, equal to 1 if the ramp changes direction from h to j (or from j to h) at block i, 0 otherwise (h,j∈R_{L} and h≠j).
a_{i,j}: binary, for each arc from a block i to a block j equal to 1 if i and j are selected as ramp blocks, 0 otherwise (i≠j).

### Objective Function 4:

$${min}_{ϰ , y} \{ {\sum }_{i ∈ N} {c}_{i} \cdot {ϰ}_{i} + {{{\sum }_{i ∈ N}}_{h , j ∈ {R}_{i}}}_{h \neq j} {p}_{i}^{h , j} \cdot {v}_{i}^{h , j} \} \qquad ( 1 )$$

### Subject to:

$$\begin{matrix}{ϰ}_{i} \leq {ϰ}_{j} ∀ i ∈ N , ∀ j ∈ {Γ}_{i}^{+} & ( 2 ) \\ {r}_{i} \leq {ϰ}_{i} ∀ i ∈ N & ( 3 ) \\ {r}_{i} \leq 1 - {ϰ}_{j} ∀ i ∈ N , ∀ j ∈ {Γ}_{i}^{-} & ( 4 ) \\ {a}_{i , j} \leq {r}_{i} ∀ i ∈ N , ∀ j ∈ {R}_{i} & ( 5 ) \\ {a}_{i , j} \leq {r}_{j} ∀ i ∈ N , ∀ j ∈ {R}_{i} & ( 6 ) \\ {r}_{i} + {r}_{j} \leq 1 + {a}_{i , j} ∀ i ∈ N , ∀ j ∈ {R}_{i} & ( 7 ) \\ {\sum }_{j ∈ i} {a}_{i , j} = 1 & ( 8 ) \\ {\sum }_{i ∈ E} {a}_{i , t} = 1 & ( 9 ) \\ {\sum }_{i ∈ I} {a}_{i , s} = 0 & ( 10 ) \\ {\sum }_{j ∈ E} {a}_{i , j} = 0 & ( 11 ) \\ {\sum }_{j ∈ {A}^{-}} {a}_{i , j} = {\sum }_{i ∈ {A}^{+}} {a}_{j , i} ∀ i ∈ N & ( 12 ) \\ {a}_{h , i} + {a}_{i , j} + {a}_{j , i} + {a}_{i , h} \leq {v}_{i}^{h , j} + 1 ∀ i ∈ N , ∀ h , j ∈ {R}_{i} , h \neq j & ( 13 ) \\ {v}_{i}^{h , j} \leq {a}_{h , i} + {a}_{i , j} ∀ i ∈ N , ∀ h , j ∈ {R}_{i} , h \neq j & ( 14 ) \\ {v}_{i}^{h , j} \leq {a}_{j , i} + {a}_{i , h} ∀ i ∈ N , ∀ h , j ∈ {R}_{i} , h \neq j & ( 15 ) \\ {a}_{i , j} + {a}_{j , i} \leq 1 ∀ i , j ∈ N & ( 16 ) \\ {x}_{i} , {r}_{i} , {a}_{i , j} , {v}_{i}^{h , j} ∈ ( 0 , 1 \} , ∀ i , j ∈ N & ( 17 )\end{matrix}$$

Objective function (1) minimises the cost of the blocks extracted due to the ramp construction plus the cost of the changes of directions (switch-backs) in the ramp. Constraint (2}) ensures the vertical precedences in the extraction of any block. Constraint (3) imposes that every block flagged as ramp must be extracted. Constraint (4) avoids building a ramp in the air.

Constraints (5) to (7) flag the blocks rᵢ and rⱼ if only if the arc a_{i,j} is selected. Constraints (8) and (9) force one of the blocks in I and one of the blocks in E to be selected as a starting and finishing point for the ramp respectively. Constraints (10), (11) and (12) ensure the connectivity of the ramp. Constraints (13) to (15) identify the change of direction at each segment of the ramp. Constraint (16) avoids the ramp returning back to the same position. Finally, constraint (17) defines the scope of the variables.

In an alternative embodiment a binary linear model to find the minimum cost ramp is formulated. The inputs for the model are divided into two types: the geological inputs, which will include the geological block model, the topography, the contour of the pit, and the dependencies between blocks based on the required pit slopes; and operational inputs, which include various costs, the ramp width, and the set of possible starting and final points for the ramp. The geological model is assumed to be represented as a regularly spaced set of blocks (equal dimensions in coordinates x and y), and must include the contour of the pit shape we are aiming to achieve. To reduce the size of the problem, blocks that are too far from the contour of the pit can be discarded. We assume the ramp width is equal to the block size in x (dx) or y (dy)) and the dimension in z (dz) represents the maximum ramp gradient. For a standard block model this may necessitate first dividing every block into several horizontal slices.

To consider the stripping associated with the ramp, we define a set of vertical precedences (upward), or blocks above the ramp, that need to be extracted to ensure a minimum wall slope. Similarly, to avoid the construction of the ramp above excavated blocks, we consider a set of vertical precedences (downward) to ensure that no block corresponding to the floor of a ramp is extracted.

Formally, the precedence relationships are represented in terms of the digraph [symbol] ₁=( [symbol] ₁, [symbol] ₁) where [symbol] ₁ is the set of blocks and (u, v)∈ [symbol] ₁ only if the block u must be extracted before the block v. Similarly, the condition that the ramp cannot be built above excavated blocks is represented by a digraph [symbol] =( [symbol] ₂, [symbol] ₂) where (u, v)∈ [symbol] ₂ represents the constraint that if the block u is selected as ramp, then the block v must not be extracted.

The ramp is represented as a connected path of adjacent blocks from S to T (two artificial blocks that represent the starting and ending points of the ramp). Formally, the possible adjacencies between blocks is represented in terms of the digraph [symbol] ₃=( [symbol] ₃, [symbol] ₃), where there is one vertex v∈ [symbol] ₃ for each block that can be selected as part of a ramp, plus the initial vertex S and the final vertex T. The set of arcs (u, v)∈ [symbol] ₃ consists of all pairs of vertices that can be selected as adjacent blocks in any feasible ramp. Additionally, we add one edge from S to every node that can be selected to begin the ramp, and one edge per vertex that can end the ramp to T.

### Indices, Sets and Parameters:

d∈ [symbol] : types of change of direction (e.g. slight left turns, right sharp turn, switchbacks, etc.).
[symbol] ′₃: Set of arcs in [symbol] ₃ other than the arcs that end at vertex T, [symbol] ′₃= [symbol] ₃−{(i,j) such that j=T}.
[symbol] ″₃: Set of arcs in [symbol] ₃ other than the arcs that start at vertex S or end at vertex T, [symbol] ″₃= [symbol] ₃−{(i,j) such that i=S or j=T}.
[symbol] : a mapping function [symbol] : {(i,j,k)|(i,j),(j,k)∈ [symbol] ″₃}→ [symbol] .
Cᵢ: extraction cost of block i.
H_{i,j}: haulage cost associated with arc (i,j)∈ [symbol] ″₃. Note that the haulage cost H_{i,j} of any arc (i,j) should account for the total tonnage that will traverse that arc over the life of the mine.
Pᵢ^{d}: change of direction cost at block i, where d∈ [symbol] is the type of change of direction.

### Variables:

rᵢ: binary, equal to 1 if the block i is selected as a ramp, 0 otherwise.
xᵢ: binary, equal to 1 if the block i is extracted, 0 otherwise.
vᵢ^{d}: binary, equal to 1 if the ramp undergoes a change in direction of type d at block i, 0 otherwise.
a_{i,j}: binary, equal to 1 if the arc (i,j)∈ [symbol] ₃ is selected as a segment of the ramp, 0 otherwise.

### Objective Function 5

$$Min : {\sum }_{i ∈ {v}_{1}} {C}_{i} \cdot {x}_{i} + \text{?} {H}_{i , j} \cdot {a}_{i , j} + {\sum }_{i ∈ {v}_{a}} \text{?} {P}_{i}^{d} \cdot {v}_{i}^{d}$$

$$\text{?} \text{indicates text missing or illegible when filed}$$

The objective function 5 minimises the cost of the blocks extracted due to the ramp construction together with the haulage cost and those costs associated with changes of direction of the ramp.

### Geotechnical Constraints:

$$\begin{matrix}{x}_{i} \leq {x}_{j} ( i , j ) ∈ {A}_{1} & ( 1 ) \\ {r}_{i} \leq {x}_{i} i ∈ {V}_{1} & ( 2 ) \\ {r}_{i} \leq 1 - {x}_{j} ( i , j ) ∈ {A}_{2} & ( 3 )\end{matrix}$$

Constraint (1) ensures the vertical precedences are honoured in the extraction of any block. Constraint (2) ensures that every block flagged as part of the ramp must be extracted. Constraint (3) avoids building a ramp in the air.

### Ramp Constraints:

$$\begin{matrix}{\sum }_{( i , j ) ∈ {A}_{3}^{'}} {a}_{i , j} \leq {r}_{j} & ( 4 ) \\ {r}_{i} + {r}_{j} \leq 1 + {a}_{i , j} ( i , j ) ∈ {A}_{3}^{″} & ( 5 ) \\ {\sum }_{( i , j ) ∈ {A}_{3}} {a}_{i , j} {\sum }_{( j , k ) ∈ {A}_{3}} {a}_{j , k} = \{ \begin{matrix}- 1 , if j = S \\ 1 , if j = T \\ 0 , if j \neq S and j \neq T\end{matrix} & ( 6 )\end{matrix}$$

Constraints (4) to (5) flags the block j as belonging to the ramp if and only if the block i belongs to the ramp and the arc a_{i,j} has been selected. Constraint (6) ensures the connectivity of the ramp.

### Change of Direction Constraints:

a_{i,j}+a_{j,k}≤vⱼ^{d}+1 (i,j),(j,k)∈ [symbol] ″₃, d= [symbol] (i,j,k) (7)

Constraint (7) identifies the change of direction at each segment of the ramp.

### Scope of the Variables:

xᵢ,rᵢ,a_{u,v}vⱼ^{d}∈{0,1} i∈ [symbol] ₁,d∈ [symbol] (u,v)∈ [symbol] ₃,j∈ [symbol] ₃ (8)

Finally, Constraint (8) defines the scope of the variables, all of which are binary.

Embodiments of mine planning systems, for example implemented in software executable in a computer system (either using stand-alone processing and memory hardware, cloud processing and memory resources, or a combination of both) can utilise any or all of the disclosed bubble model excavation, pushback, scheduling and ramp design methods within planning modules. Such systems 1100 can include:
an input interface 1132 to enable input of user-controlled parameters, such as target tonnage for pushbacks, compactness factor, economic data etc;
a data access interface 1145 for accessing databases 1140 or other storage repositories storing data such as mine block models, scheduling data, and optionally existing mine plans;
processing 1110 and memory 1120 resources for executing one or more software modules for mine planning processes; such modules can include a clustering module 1150, scheduling module 1155, excavation module 1160, bubble pit pushback design module 1170, and a ramp design module 1165;
an output interface 1135 to enable output of mine planning data to a user for assessment and use in implementation of a mine plan. For example, the output interface may include a display module or a formatting module configured to prepare data in a format enabling output and display via external systems. The excavation module may be configured to implement planning for caving, stoping or other excavation embodiments. The mathematical model 1190 may be stored in system memory 1120 for application by the various modules. Resulting mine plans, designs or schedules generated by the system can be stored in memory 1120 or output via the user interface 1130.

In an embodiment the system may be implemented in a computer having a user interface 1130, processor 1110 and memory 1120. Alternatively, a computer, tablet or other device may be utilised as a user interface to access an online server implementing the system. Think or thick client embodiments may be utilised.

In an embodiment, the described mining design methods may be implemented in a software as a service embodiment, to enable existing mine designs (for example for mines already in operation) to be input to enable pushback and/or ramp redesign and optimisation for ongoing operations.

The inventors believe they have devised the first and only method to design pushbacks for open cut mines, which simultaneously satisfy operational constraints and maximise NPV. This could be used by large mining companies with in-house design capability, mining consulting companies and mining software providers. Our invention fits in the core of the open pit mine planning value chain and allows to both optimise and automate the pushback design stage.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A computer implemented method of mine design, the method comprising:
obtaining a three-dimensional (3D) model for a mine, the 3D model characterizing physical material of the mine as a plurality of geometric elements, each geometric element representing a portion of the physical material extractable from the mine;
applying a mathematical model, based on mathematical modelling of behavior of connected bubbles, to cluster geometric elements from the three-dimensional (3D) model based on physical location and properties of the physical material for each of the geometric elements; and
selecting at least one set of a plurality of contiguous geometric elements for extraction.

2. The method as claimed in claim 1 wherein each set of a plurality of contiguous blocks is associated with a phase of a mining process.

3. The method as claimed in claim 1 wherein the mathematical model includes mathematical constraints reflecting operational constraints for the mine type.

4. The method as claimed in claim 3 wherein the mine type is an open cut mine and the mine design comprises push backs, the operational constraints include: connectivity, minimum bench width and appropriate angles between pushbacks.

5. The method as claimed in claim 4 wherein for each pushback the mathematical model balances selection of contiguous blocks to minimize geometric surface area while maximizing economic value for each pushback.

6. The method as claimed in claim 5 wherein the mathematical model includes a geometric compactness tradeoff factor to enable an operator controllable weighting between maximizing economic value and pushback geometry to be defined and input to the mathematical model.

7. The method as claimed in claim 6 wherein the mathematical model comprises:
$$max z = ( 1 - λ ) {\sum }_{p ∈ P} {W}_{p} {\sum }_{b ∈ B} {V}_{b} \cdot {x}_{b} - λ \cdot ( {\sum }_{p ∈ P} {W}_{p} ( {\sum }_{b ∈ B} {S}_{b} \cdot {x}_{bp} - {{\sum }_{b ∈ B}}_{\hat{b} ∈ {\hat{B}}_{b}} {I}_{b \hat{b}} \cdot {y}_{b \hat{b} p} ) )$$
subject to:
$$\begin{matrix}{\sum }_{b ∈ B} {A}_{p} \cdot {x}_{bp} = {\overline{A}}_{p} ∀ p ∈ P & ( 6 ) \\ {x}_{bp} + {x}_{\hat{b} p} - {y}_{b \hat{b} p} \leq 1 ∀ b ∈ B , ∀ \hat{b} ∈ {\hat{B}}_{b} , ∀ p ∈ P & ( 7 ) \\ {y}_{b \hat{b} p} \leq {x}_{bp} ∀ b ∈ B , ∀ \hat{b} ∈ {\hat{B}}_{b} , ∀ p ∈ P & ( 8 ) \\ {y}_{b \hat{b} p} \leq {x}_{\hat{b} p} ∀ b ∈ B , ∀ \hat{b} ∈ {\hat{B}}_{b} , ∀ p ∈ P & ( 9 ) \\ {\sum }_{ρ \leq p} {x}_{bp} \leq {\sum }_{ρ \leq p} {x}_{\overline{b} p} ∀ b ∈ B , ∀ \overline{b} ∈ {\overline{B}}_{b} , ∀ p ∈ P & ( 10 ) \\ {\sum }_{p ∈ P} {x}_{bp} \leq 1 ∀ b ∈ B & ( 11 ) \\ ( x , y ) ∈ Ω ( other constraints ) & ( 12 )\end{matrix}$$
Where:
Sets and notation:
b∈B: Set of blocks {0, 1, . . . , B}
\hat{b}∈ [symbol] : Set of blocks that are adjacent to block b.
p∈P: Set of pushbacks (clusters) {0, 1, . . . , P}.
b̅∈B̅_{b}: Set of slope precedences for block b.
Parameters:
S_{b}: external surface area of block b
I_{b\hat{b}}: intersecting surface area between block b and \hat{b}
A_{b}: amount of attribute A associated to block b
Āₚ: total amount of attribute A required in pushback p
Wₚ: weight for the pushback p
V_{b}: economic value of block b
λ: compactness factor. Weight (ranging from 0 to 1) to balance the importance of the two objectives in the optimization problem
Variables:
x_{bp}: binary, equal to one if the block b is assigned to pushback p, zero otherwise
y_{b\hat{b}p}: binary, equal to one if blocks b and \hat{b} belongs to pushback p, zero otherwise.

8. The method as claimed in claim 7 further comprising the steps of adjusting the compactness factor and producing a further pushback design.

9. (canceled)

10. The method as claimed in claim 3 wherein the mine type is an underground mine where operational constraints include any one or more of connectivity and width.

11. The method as claimed in claim 10 wherein the operational constraints further includes geotechnical constraints.

12. The method as claimed in claim 3 further comprising the step of determining a time period for extraction for each set of a plurality of contiguous blocks.

13. The method as claimed in claim 12 further comprising applying a compactness factor.

14. (canceled)

15. A method of designing ramps for a set of pushbacks based on a linear programming formulation to find a minimum cost ramp with vertical and horizontal alignment constraints for a given pit and a given ramp width, taking into account stripping associated with ramp excavation, by applying a geological model is assumed to be represented as a regularly spaced set of blocks including the topography of the pit, and ramp width equivalent to the block size in x or y and the dimension in z represents the maximum ramp slope
$$( max . slope \leq \frac{z}{ϰ} or \frac{z}{y} ) .$$
wherein the set of pushbacks are designed based on mathematical modelling of behavior of connected bubbles.

16. The method of claim 15 wherein the ramp design is calculated in accordance with:
Sets:
N: Set of blocks in the block model.
Aᵢ⁺: Set of blocks j such that there is an arc from j to i.
Aᵢ⁻: Set of blocks i such that there is an arc from i to j.
Γᵢ⁺: Set of vertical precedences of block i (upward).
Γᵢ⁻: Set of vertical precedences of block i (downward).
Rᵢ: Set of all possible ramp directions from block i.
I: Set of possible ramp starting blocks.
E: Set of possible ramp ending blocks.
Parameters:
cᵢ: extraction cost of block i.
pᵢ^{h,j}: change of direction cost in ramp segment i, where h is the incoming direction and j is the outgoing direction at i with h, j∈Rᵢ and h≠j.
Variables:
rᵢ: binary, equal to 1 if the block i is selected as a ramp, 0 otherwise.
xᵢ: binary, equal to 1 if the block i is extracted, 0 otherwise.
vᵢ^{h,j}: binary, equal to 1 if the ramp changes direction from h to j (or from j to h) at block i, 0 otherwise (h, j∈Rᵢ and h≠j).
a_{i,j}: binary, for each arc from a block i to a block j equal to 1 if i and j are selected as ramp blocks, 0 otherwise (i≠j).
Objective function 4:
$${min}_{ϰ , y} \{ {\sum }_{i ∈ N} {c}_{i} \cdot {ϰ}_{i} + {{{\sum }_{i ∈ N}}_{h , j ∈ {R}_{i}}}_{h \neq j} {p}_{i}^{h , j} \cdot {v}_{i}^{h , j} \} \qquad ( 1 )$$
Subject to:
$$\begin{matrix}{x}_{i} \leq {x}_{j} ∀ i ∈ N , ∀ j ∈ {Γ}_{i}^{+} & ( 2 ) \\ {r}_{i} \leq {x}_{i} ∀ i ∈ N & ( 3 ) \\ {r}_{i} \leq 1 - {x}_{j} ∀ i ∈ N , ∀ j ∈ {Γ}_{i}^{-} & ( 4 ) \\ {a}_{i , j} \leq {r}_{i} ∀ i ∈ N , ∀ j ∈ {R}_{i} & ( 5 ) \\ {a}_{i , j} \leq {r}_{j} ∀ i ∈ N , ∀ j ∈ {R}_{i} & ( 6 ) \\ {r}_{i} + {r}_{j} \leq 1 + {a}_{i , j} ∀ i ∈ N , ∀ j ∈ {R}_{i} & ( 7 ) \\ {\sum }_{j ∈ I} {a}_{s , j} = 1 & ( 8 ) \\ {\sum }_{i ∈ E} {a}_{i , t} = 1 & ( 9 ) \\ {\sum }_{i ∈ I} {a}_{i , s} = 0 & ( 10 ) \\ {\sum }_{j ∈ E} {a}_{t , j} = 0 & ( 11 ) \\ {\sum }_{j ∈ {A}^{-}} {a}_{i , j} = {\sum }_{i ∈ {A}^{+}} {a}_{j , i} ∀ i ∈ N & ( 12 ) \\ {a}_{h , i} + {a}_{i , j} + {a}_{j , i} + {a}_{i , h} \leq {v}_{i}^{h , j} + 1 ∀ i ∈ N , ∀ h , j ∈ {R}_{i} , h \neq j & ( 13 ) \\ {v}_{i}^{h , j} \leq {a}_{h , i} + {a}_{i , j} ∀ i ∈ N , ∀ h , j ∈ {R}_{i} , h \neq j & ( 14 ) \\ {v}_{i}^{h , j} \leq {a}_{j , i} + {a}_{i , h} ∀ i ∈ N , ∀ h , j ∈ {R}_{i} , h \neq j & ( 15 ) \\ {a}_{i , j} + {a}_{j , i} \leq 1 ∀ i , j ∈ N & ( 16 ) \\ {x}_{2} , {r}_{i} , {a}_{i , j} , {v}_{i}^{h , j} ∈ \{ 0 , 1 \} , ∀ i , j ∈ N & ( 17 )\end{matrix}$$

17. A computer implemented mine planning method comprising the steps of:
obtaining a mine 3D model defining three dimensional geological resources of a mine as a regular grid of a plurality prismatic blocks, wherein each block represents a defined volume of material, and wherein block characterisation data for each block includes at least coordinate data, physical characteristic data and assigned economic value data;
defining a target pushback tonnage for each pushback; and
determining one or more pushbacks for the mine using the block characterization data, the target pushback tonnage a plurality of contiguous blocks to comprise the pushback by applying a mathematical model for operational constraints of connectivity, minimum bench width and appropriate angles between pushbacks to select from the mine block model, based on physical location and economic value estimates for each block, a plurality of contiguous blocks having a combined weight equal to or less than the target pushback tonnage to comprise each pushback, wherein the mathematical model is based on mathematical modelling of behavior of connected bubbles.

18. The method as claimed in claim 17 wherein the mathematical model is based on mathematical modelling of behavior of connected bubbles, and for each pushback the mathematical model balances selection of continuous blocks to minimize geometric surface area while maximizing economic value for each pushback.

19. The method as claimed in claim 18 wherein the mathematical model includes a geometric compactness tradeoff factor to enable an operator controllable weighting between maximizing economic value and pushback geometry to be defined and input to the mathematical model.

20. The method as claimed in claim 18 wherein the mathematical model comprises:
$${max}_{x , y} \{ {\sum }_{i ∈ N} {v}_{i} \cdot {x}_{i} - c \cdot ( {\sum }_{i ∈ N} 6 \cdot {l}_{i}^{2} \cdot {x}_{i} - {{\sum }_{i ∈ N}}_{j ∈ Ωi} {l}_{i}^{2} \cdot {y}_{i , j} ) \}$$
subject to:
$$\begin{matrix}{\sum }_{i ∈ N} {w}_{i} \cdot {x}_{i} - W \leq 0 & ( 4 ) \\ {x}_{i} - {x}_{j} \leq 0 ∀ i ∈ N , ∀ j ∈ {Γ}_{i}^{+} & ( 5 ) \\ {x}_{i} + {x}_{j} - {y}_{i , j} \leq 1 ∀ i ∈ N , ∀ j ∈ {Ω}_{i} & ( 6 ) \\ {x}_{i} , {y}_{i , j} ∈ \{ 0 , 1 \} ∀ i , j ∈ N & ( 7 )\end{matrix}$$
Where:
N: Set of blocks in the block model
Ωᵢ: Set of adjacent blocks to block i
Γᵢ⁺: Set of vertical precedences of block i (upwards)
c: compactness factor
vᵢ: economic value of block i
lᵢ: length of the block t
wᵢ: tonnage of the block i
W: total tonnage of the bubble pit
xᵢ: binary, equal to one if the block t is extracted, zero otherwise
y_{i,j}: binary, equal to one if blocks i and j are extracted, zero otherwise.

21. The method as claimed in claim 20 further comprising the steps of adjusting the compactness factor and producing a further pushback design.

22. (canceled)

23. The method as claimed in claim 21 further comprising the step of performing ramp design for one or more pushback designs, wherein the ramp design is based on a linear programming formulation to find a minimum cost ramp with vertical and horizontal alignment constraints for a given pit and a given ramp width, taking into account stripping associated with ramp excavation, by applying a geological model that is assumed to be represented as a regularly spaced set of blocks including the topography of the pit, and ramp width equivalent to the block size in x or y and the dimension in z represents the maximum ramp slope
$$( max . slope \leq \frac{z}{ϰ} or \frac{z}{y} ) .$$
wherein the set of pushbacks are designed based on mathematical modelling of behavior of connected bubbles.

24-25. (canceled)

26. The method as claimed in claim 13, wherein the compactness factor is iteratively adjusted and pluralities of sets of elements reselected to search for an optimal extraction schedule.
